(19) United States
(12) Patent Application Publication
(10) Pub. No.: US 2014/0172479 A1
(43) Pub. Date: Jun. 19, 2014

(54) Integrated Customer Profiling, Service Provider Matching and Smart Order, Creation System and Method

(71) Applicants: Lisa A. Gallagher, Irvine, CA (US); John W. VanZandt, Mission Viego, CA (US)

(72) Inventors: Lisa A. Gallagher, Irvine, CA (US); John W. VanZandt, Mission Viego, CA (US)

(21) Appl. No.: 13/716,020

(22) Filed: Dec. 14, 2012

(51) Int. Cl. G06Q 10/06

(52) U.S. Cl. CPC G06Q 10/063114
USPC 705/7.15

(57) ABSTRACT

A computer-implemented home maintenance and service system and method provide automated, integrated user profiling, service provider matching, and work order creation. The system and method facilitate the computer-implemented, automatic creation of service transactions, in the form of actionable work orders that can be utilized by service providers. These service transactions are established in a vendor-provided transaction brokering system that includes a home profile database, a service request match processor, and a service order processor. The system also houses and uses a comprehensive database repository for all home related information.

### RELATED APPLICATIONS

This application is a continuation-in-part of the nonprovisional patent application with docket number ABRI-01ORD, filed on Dec. 13, 2012, which claims the benefit of U.S. Provisional Application 61/569,882 filed Dec. 13, 2011.

### TECHNICAL FIELD

The present invention relates to a system and method for managing home maintenance information and providing maintenance service.

### BACKGROUND

The nature of household maintenance is inefficient on the part of the homeowner and contractor. Homeowners often cannot recall the date or details of previous repairs, and they lack the expertise to adequately explain a home system or an item that requires repair. Additionally, the customer may lack historical paperwork going back to initial construction or installation of the items in question, or any subsequent repairs/replacements that were performed over time. Files and paper records for warranty repairs and replacement items may be problematic from a space and convenience perspective—particularly as time in the residence increases.

Homeowners and residents often lack the time and expertise to effectively manage their homes. Maintenance is deferred until there is an unavoidable break down. Then, a homeowner or resident must find a technician or contractor to address a maintenance or repair issue on an immediate basis combing through lists, checking references, negotiating pricing and scheduling at a moment's notice.

Currently, maintenance contractors have little to no knowledge about the exact nature of the home infrastructure or appliance to be repaired or maintained before they visit a residence. The lack of information creates inefficiency for both the resident and the contractor. Often, follow up visits and trips to a supply store must take place before a repair or maintenance activity can be completed. This lengthens the time to completion, creates additional costs, and requires multiple visits on the part of the contractor which also disrupts the homeowner's activities. In addition, there is no service that aggregates multiple service providers to address seasonal home maintenance on one to two days taking less of the homeowner's time.

Various service providers may offer/advertise general “handyman” services, incorporating some broad level of expertise and experience into their service offering that spans various trades such as electrical, plumbing, woodworking, masonry, landscape/hardscape, mechanical appliance/equipment repair, etc. These handyman services generally are confined to a local geographic presence, and lack automation for efficient matching and correlation of customer needs to anything other than the services provided by an individual or singular service providers.

### SUMMARY OF THE INVENTION

The present invention provides systems and methods for computer-implemented home maintenance and service. The systems include a home profile database, a service request match processor, and a service order processor. The home profile database provides a comprehensive database repository for user information and a home profile of all home related information. The service request match processor contains a matching program that compares a home maintenance service request submitted by a customer with a service provider database and generates a match of the home maintenance service request with a best fit service provider, based on several criteria. The service order processor encapsulates home profile information, service request information, and service provider information to prepare a work order which is provided to a service provider. The service order processor subsequently processes completion of the work order. Customers, service providers, and service provider staff members interface with the system through portals, which typically will be internet user, service provider, and provider staff member dashboards.

A method of home maintenance and service in the present invention will include customer initiation of a service request for home maintenance and service through a portal of the service system. The system combines the service request with an account profile for the customer from a customer account profile database, and presents the customer's service request and account profile to a matching program in the service request match processor. The matching program matches the customer's service request and account profile to a service provider database and home related information from the home information database. The matching program then creates an initial work order and sends it through a portal to service providers that have been matched to the service request by the matching program. Service providers may accept, reject, or ignore the initial work order. An accepted initial work order is sent from the service provider's portal to the system, and is analyzed with other acceptances by the matching program. The matching program selects an available service provider and notifies the selected service provider(s) through the service provider's portal. Upon receipt of acceptance of the selection by the service provider, the service order processor creates a final work order by combining the service request and a service provider profile from the matching program and home information related to the service request from the home profile database. The final work order is provided to the service provider through the portal, and the service provider utilizes the work order to carry out the service request at the home of the customer. The service provider then completes the final work order by submitting it to the service order processor through the service provider portal. The service order processor finally updates the home profile database with information from the completed work order.

### BRIEF DESCRIPTION OF THE DRAWINGS

For a further understanding of the objects and advantages of the present invention, reference should be had to the following detailed description, taken in conjunction with the accompanying drawings, in which like parts are given like reference numbers and wherein:

FIG. 1 is a schematic overview of the technical functions and process flow of a preferred embodiment of the system and method.

FIG. 2 is a schematic overview of the home profile workflow, showing the information gathered in the home profile and the flow of information to other modules in a preferred embodiment.

FIG. 3 is a schematic overview of the matching program method, outlining the major components and process steps.

FIG. 4 is a schematic overview of the order creation method, outlining the major components and process steps.

FIG. 5 is a schematic overview of the brokering system design employed in the preferred embodiment, showing the integration of the various Portals/Dashboards, the supporting database servers, and the program cluster where the PMOC logic and software modules reside.

FIG. 6 is a schematic overview of the 4-tier architecture of the system design employed in the preferred embodiment.

FIG. 7 is a schematic overview of the user interaction workflow within the system design employed in the preferred embodiment.

FIG. 8 is a narrative flowchart of the home profile Creation process within the Homeowner Dashboard interface.

FIG. 9 is a narrative flowchart of the home profile improvements entry process within the Homeowner Dashboard interface.

FIG. 10 is a narrative flowchart of the home profile document entry process within the Homeowner Dashboard interface.

FIG. 11 is a narrative flowchart of the Service Request submission process within the Homeowner Dashboard interface.

FIG. 12 is a narrative flowchart of the optional Seasonal Package selection process within the Homeowner Dashboard.

FIG. 13 is a narrative flowchart of the optional Recommended Services selection process within the Homeowner Dashboard.

FIG. 14 is a narrative flowchart of the matching program selecting the appropriate Contractor(s) to fulfill the needs of a Service Request.

FIG. 15 is a narrative flowchart of the contractor work order creation process.

FIG. 16 is a narrative flowchart of the format and creation process for the work order, including preconditions and triggers to initiate the process.

FIG. 17 is a narrative flowchart of the work order completion process.

FIG. 18 is a schematic overview of the work order completion process.

### DETAILED DESCRIPTION

In light of the shortcomings and problems described above, there is a need for an online service that maintains home information in a home profile and a list of qualified service providers, such that the online service can efficiently and automatically respond to a service request to match a qualified service provider to perform the service requested.

I have invented a new, intelligent, computer-implemented/based automated home maintenance system. It accomplishes the following: 1) creating and maintaining customer and contractor profile; 2) storing information about the home, previous maintenance and repairs and home improvements; 3) automating handling of customers' service requests by intelligently matching the request, including desired service date and services to be performed, to information contained in a repository of service providers/contractors; 4) automatically generating work orders for the services and collecting information about the repair or maintenance for the home profile; and 5) aggregating maintenance needs to be matched and completed by one or more contractors in one to two visits. A preferred embodiment is directed to a method for managing home maintenance activities of a dwelling homeowner/resident connected to a service brokering system, in particular via the Internet.

My home maintenance system and method addresses homeowner needs, as well as reduces risk, minimizes unnecessary expense, maximizes the potential for proper repairs, and minimizes inconvenience and inefficiency for both the customer and the service providers.

My invention provides improved online systems and methods for computer-implemented home maintenance and service. To date, online services have provided searchable lists, or databases, of service providers that the customers may peruse and initiate contact with the various listed service providers with regard to their specific service needs. These may involve memberships for free or on a fee basis, and may provide some rating criteria based on customer experiences with the listed service providers. Others match homeowners to multiple contractors for even the most routine tasks requiring the homeowner to interview, negotiate with, and schedule amongst several providers. However, the existing online services do not incorporate three critical aspects—the home profile, matching program, and order creation—that make up the more intelligent and efficient solution disclosed in the systems and methods herein.

One current online service addresses consumer's service needs for discreet repair and maintenance to a service provider by geography and soliciting competitive bids from contractors for an individual job in the process. The resident is presented with multiple, often confusing bids from a list of contractors. A similar online service collects bids from contractors for a variety of services at the request of consumers. In both of these approaches, the homeowner still has the onerous step of interviewing several providers and has no infrastructure or history of maintenance/repairs is provided to streamline the maintenance/repair process. In addition, these approaches operate on only a single maintenance/repair request at a time which requires the homeowner to interact with several contractors scheduled at different times to perform service.

Another online service provides homeowners with just a list of consumer-rated contractors from which to choose. A similar online service provides the consumer with a list of contractors based on location and project. Both of these services leave the homeowner responsible for selecting a contractor from the list and for interviewing several contractors. These services fail to provide a scheduling or a home profile feature to streamline the maintenance process. These services also fail to track previous maintenance and repair services for the consumer, leaving inefficiency in the maintenance process. Finally, these services also operate on a single maintenance/repair request at a time which requires the homeowner to interact with several contractors scheduled at different times to perform service.

Another current service option provides consumers that shop at a home supply store the ability to use a card swipe to store information about their purchases in a database. Consumers can create “to do” lists for home do-it-yourself projects. This service also contains a reminder feature to remind consumers to purchase items from the home supply store. This service has a home profile where consumers accumulate information about their home's dimensions, previously purchased items from the store, and self-identified items online. However, this approach is geared toward consumer purchases and lacks a history of maintenance and repairs to be provided to improve the efficiency of the maintenance process in the future. Additionally, it has no upload capability for consumers to archive documents that are not available virtually. Furthermore, this approach provides no means for consumers to maintain their homes through an efficient and intelligent order process.

Yet another current option for consumers is an online service that collects information from the consumer about the desired project with a heavy emphasis on home improvements rather than home maintenance. It matches the consumer's request to a number of contractors based on geography and contractor skill. The selected contractors then contact the consumer to promote their service offering. The consumer is still left with the time consuming task of interviewing several contractors. Contractors are also inefficiently spending their time promoting their services rather than performing services which generates revenue for their business and services for consumers. Additionally, this approach lacks a prior history or home profile information with each order creating inefficiency in the process.

My new system manages customers' service requests coming from homeowners, apartment dwellers, and other residential occupants. These requests require residence-related warranty repairs, inspections, periodic maintenance services, and break-and-fix repair services. The system retains home profile information along with the service request information.

Service transactions transpire between various parties depending on local conditions and use cases. These parties include, but are not limited to, end-user customers purchasing a service (such as dwelling owners, renters, residents), property management service providers (including property owners representing renters or multiple residential dwellings), service providers/contractors (including property inspection services, maintenance and repair services, warranty repair service providers, construction contractors); and brokering system provider staff (including executives and management, sales staff, customer service representatives (CSRs)).

My system and method greatly enhance the speed and efficiency of the maintenance process and reduces the time to complete an order than may otherwise be created by today's non-automated processes. Additionally, this preferred embodiment provides a repository for the homeowner to archive all purchase, maintenance, repair, and improvement information conveniently in one location.

A preferred method of the invention is initial use in the residential services market, providing a new and unique service request model for more efficiently accumulating and providing information about a customer's needs to the selected service provider. This preferred embodiment relates to a method and system for facilitating the computer-implemented, automatic creation of service transactions, in the form of actionable work orders that can be utilized by service providers/contractors. These service transactions will be established in a vendor-provided transaction brokering system.

This embodiment of the invention also provides a comprehensive repository for all home related information; infrastructure, appliances, decorative appointments, exterior, home network, and improvements accompanied by photos. This embodiment makes home management more efficient and easier for homeowners, residents, and contractors.

My system and method provide for integrated customer profiling, service provider matching and smart order creation. The overall system and method include three critical aspects—the home profile, matching program, and order creation—that make up the inventive, intelligent and efficient solution. These aspects are contained within several primary components which contribute to the overall data flow and functionality in a preferred embodiment. These primary components include the home profile database, the service request match processor, and the service order processor. These modules typically are accessed via the Internet through typical means, including a preferred embodiment of customer and contractor dashboards

Customer/user dashboards or portals as disclosed herein allow users to provide customer or contractor information to the service system. This customer dashboard information includes user name, contact information, address, and payment method. In like fashion, service providers/contractors use service provider/contractor dashboards or portals to provide user data which includes name, contact information, licensing, insurance, references along with services and skills they are capable of providing and geographic data regarding their location in relation to the customer residence. The service brokering system collects and provides additional historical information regarding customer satisfaction with past performance.

The home profile database disclosed herein enables users to accumulate a home profile by supplying the system with home profile characteristics specific to the home system or appliance requiring maintenance or repair. The system stores information about the model, purchase date, price paid and warranty. Users supply photos of appliances and home systems. The system accumulates information about maintenance, repairs, improvements, and decorative items.

Through the service request match processor described below, the user schedules a service request by using the internet to connect to a customer dashboard. Information about the desired service request and desired service dates is compared and contrasted with the available service provider/contractor profile information, along with dynamically gathered information regarding availability of the service provider/contractor. The brokering system then automates the matching process and work order generation process, with results being made available online through internet connections from any browser-capable device.

The service order processor of the system described herein provides homeowner contact and service location information and uniquely sends accumulated information about past maintenance and repair efforts, plus electronic or digital photos, such as those taken through a smart phone, tablet device or digital camera, to the contractor for use in determining the most efficient means of repairing the item. To complete the process, the contractor provides historical information about the work performed, and this information is added to the home profile for future use in the maintenance process. Photos supplied by the contractor are archived in the work order to document work performed.

This new level of automation and intelligence of the maintenance system and method speeds up the overall service request transaction time, allowing for faster processing and scheduling with less human intervention, expense, and margin for error, while still allowing for exception handling as required to address real-world conditions and scheduling conflicts.

The system disclosed herein retains a database of service providers/contractors skilled in the art of typical residential maintenance and repair services, along with the results of a vetting and customer rating system that scores each service provider/contractor network member based on past performance in a number of specific rating criteria. For illustrative purposes of a preferred embodiment, the system will employ the Order Creation and Method modules into its decision system logic, intelligently combining customer service request information, the service provider/contractor member database, and the vetting/rating system information, along with a logic program that matches service requests with available/knowledgeable service providers.

The order creation process gathers information from the customer's home profile and automatically generates orders that become work orders utilized by the service provider at the customer's dwelling. However, it will be understood by one of ordinary skill in the art that the systems and methods described herein can be adapted and modified for other suitable applications and that such other additions and modifications will not depart from the scope hereof.

For the purposes of promoting an understanding of the principles of the invention, reference will now be made to the exemplary embodiments illustrated in the drawings, and specific language will be used to describe the same. It will nevertheless be understood that no limitation of the scope of the invention is hereby intended. Any alterations and further modifications of the inventive features illustrated herein, and any additional application of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus appearances of the phrases an “embodiment,” and “example, ” and similar language throughout this specification may, but do not necessarily, all refer to the same embodiment, to different embodiments, or to one or more of the figures. Additionally, reference to the words “embodiment” “example” or the like for two or more features, elements, etc., does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps. “Comprising” is to be interpreted broadly and including the more restrictive terms “consisting of” and “consisting essentially of.”

As used herein, a “processor” refers to a computing device, devices, system or systems, and includes but is not limited to a computer, a chip, a cloud computing system, and other variations of computing devices and systems.

Reference throughout this specification to features, advantages, or similar language does not imply that all of features and advantages that may be realized with the present invention should be or are in any single embodiment of the invention. Rather, language referring to the features and advantages is understood to mean that a specific feature, advantage or characteristic described in connection with an embodiment is included in at least one embodiment of the present invention. Thus, discussion of the features and advantages, and similar language, throughout this specification may, but does not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description or may be learned by the practice of the invention as set forth.

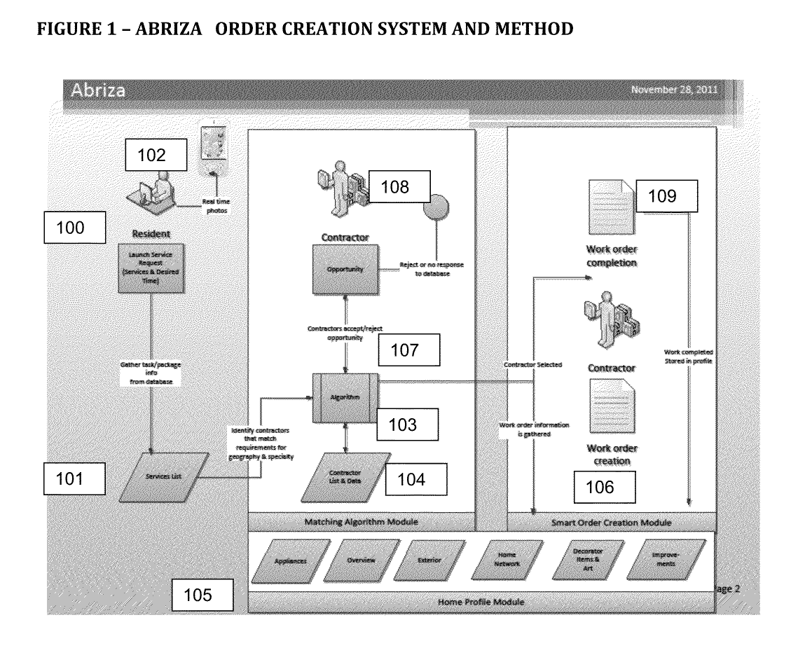

FIGS. 1-18 illustrate and describe the system and method of the present invention. FIG. 1 depicts the overall structure of the disclosed system and method. The home profile database contains all home information: infrastructure, appliances, home network information, interior design, exterior, safety devices, and improvements. It stores data in searchable form for utilization in completing service requests and in generating the work order. The home profile information is also used to create home Health Reports that describe the maintenance, repairs and improvements for the home owner and other interested parties.

The Homeowner Dashboard displays various Services List options 101 to the resident: a la Carte Service, Seasonal Package, or Recommended Services, to the user and for selecting from the predetermined list of options. A resident of the home launches a Service Request through the Homeowner Dashboard 100. The customer then selects two desired time and date combinations for service. The customer provides input for the service request, such as photos of the item to be maintained or repaired using his or her computer, tablet, or other Smart Device 102 and may enter a custom text narrative for special requests. The system stores the user selections/inputs with the user's information from the Account Profile data repository so that specifics regarding the requested service and homeowner can then be accessed by the service request match processor.

The service request match processor 103 receives the customer's Service Request in tandem with the pertinent resident account data. The system matches this information against the Service Provider/Contractor database 104 and the home profile database's repository of information concerning the residence in question 105. The matching program works iteratively with the service order processor 106 to create an initial draft of the Work Order, in the form of an Opportunity, and sends an Opportunity notification to each qualified contractor in the region 107.

Contractors indicate their availability to perform the desired work through e-mail or through the online Contractor Module and Contractor dashboard 108. All contractors that have signaled their availability are included in the program's second process which selects the available contractor that can complete all or most of the homeowner's selected tasks based on priority variables from the provider of the system/method and/or the resident. The system may select more than one available qualified contractor 1) if the Service Request includes tasks that require different technical expertise, 2) optionally if the customer has requested multiple options to review, or 3) optionally if ratings fall within a specified tolerance where rating criteria are close to equal. Ratings are resident in the system and accumulated from past customer experience. Only customers that have purchased a service from the provider of the system/method can rate a contractor.

Once the iterative matching process is complete, and an Opportunity has been accepted, the service request match processor produces and provides the service request and Contractor profile information to the service order processor 106. The service order processor gathers the appropriate infrastructure data and history from the home profile database and combines the information with the Service Request information along with photos or other documents that may have been supplied by the resident to assist in generating a complete and informative Service Request.

The service order processor then passes the finalized Work Order to the Service Provider/Contractor Dashboard 108 so that it shows up in the Contractor's work queue as a Work Order 109.

Once the contractor completes the initial Service Request visit, the Work Order completion page is filled out with a Complete or Incomplete status for each task included on the original Work Order 109. Additional work performed at the request of the resident may also be added to the Work Order. Discounts may also be applied on the premises. Incomplete tasks are assigned a specific designation of Additional Visit Required or No Additional Visit Required. The service order processor 106 handles the various scenarios indicated by the Contractor, eventually leading to the subject Work Order being closed out with a status of “complete.”

The Home Profile System and Method

A preferred embodiment of the invention takes advantage of the historical data and information repository provided through use of the home profile comprehensive database and repository for all home related information. The historical data consists of any receipts, diagrams, as-built drawings, plan drawings, appliance manuals, user manuals, pictures, warranty documents, and other pertinent information that the User may wish to upload concerning the residence and/or the installed equipment, fixtures, and fitments. This information is critical in the creation of the work orders so that on-premises staff from the Service Provider/Contractor organization may properly and completely, effect repairs and provide the contracted-for services specified by the customer without multiple visits to the premises to assess the conditions, requisition appropriate parts and return for a repair or maintenance activity.

In a preferred embodiment, the home profile module handles all tasks and transactions related to the customer's residence. These task and transactions include but are not limited to the creation of the home Profile Database or repository of information regarding the residence, updates to the home profile from the customer account through the Homeowner Dashboard, and history of Service Requests and in-process/completed Work Orders.

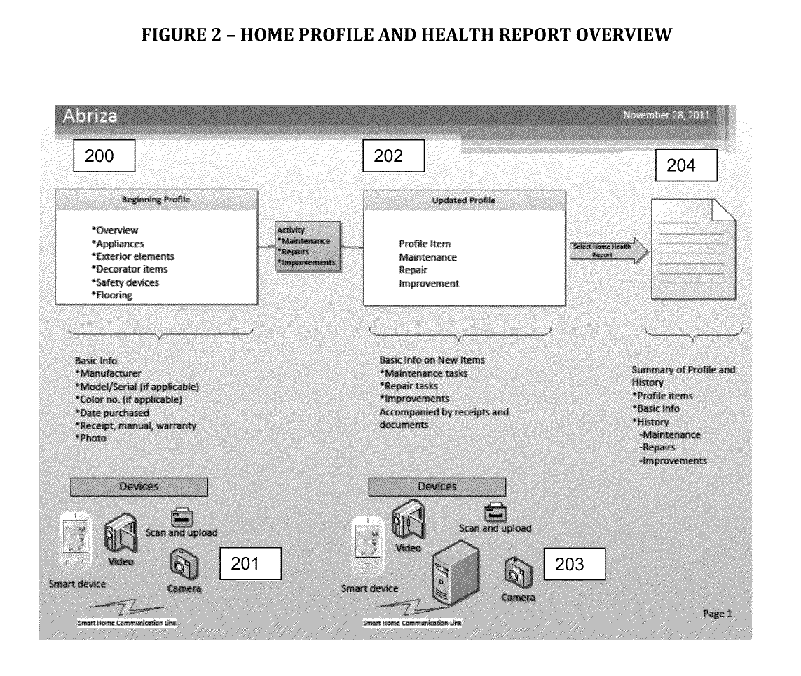

FIG. 2 depicts the overall flow of information within the home profile module. The home profile module retains a database of all residence features that may be pertinent for repair and maintenance services 200. This initial home Profile repository can be entered manually by the customer, or can be automatically uploaded into the disclosed system in the preferred embodiment through a variety of potential input devices 201.

The home profile module also retains a repository of information concerning any repair and maintenance activity at the residence 202. This activity history updates the residence features database to reflect current features and fitments within the residence, along with retaining an historical record of all changes that took place since the home profile was created. This change history includes receipts and related drawings, permits, and other documents pertinent to the subject repair or maintenance activity 204.

The home profile database again will accept inputs from a variety of sources and devices for the repair and maintenance history 203. The home profile database accepts intelligent data feeds from other types of “smart home” devices or “smart appliances”. These devices and appliances contain an onboard computing module that retains intelligent data, both static and dynamic, pertaining to the device/appliance itself, and/or any additional data points that the device or appliance is designed to monitor, such as temperature, humidity, pressure, motion, etc. They are capable of transmitting that data in a polled or asynchronous manner to a central data repository or receiving software application such as the brokering system in a preferred embodiment. These “smart home” and “smart appliances” are capable of gathering, retaining and reporting both real-time immediate status information as well as historical data for a prescribed time period. These various device inputs result in an electronic history of all Contractor- and/or Customer-induced changes to the residence history. They also provide resident data that is the basis for, or provides complementary information to, the home profile data repository in the form of status or service condition information. These devices and systems provide critical alert or alarm conditions that automatically trigger, or may be automatically incorporated into, a Service Request within the system/method. These devices and systems provide non-critical alerts or alarm conditions, such as regular service reminders or warranty expiration reminders that may be utilized by a brokering system as described in the preferred embodiment, or which may be provided to the original equipment manufacturer, or directly provided to a designated service provider specializing in repair/maintenance activities for that particular device or system.

The home profile database provides a query and reporting function that is available through the Homeowner Dashboard, along with viewing and administration controls via the Staff Dashboard. The customer can retrieve the home profile information in the form of various historical reports and status queries (Home Health Reports) that are viewed online, edited, or printed for offline storage. The user optionally controls which documents/photos are available for sharing with the service providers/contractors and thus included in the information package when a Service Request is generated.

The Service Request Match System and Method

The service request match processor intelligently compares and contrasts the requests with the service provider contact/profile data, skill sets, proximity, ratings, and historical information. The service request match processor then iteratively processes the various potential combinations or matches among all variables and prioritized criteria with no human intervention.

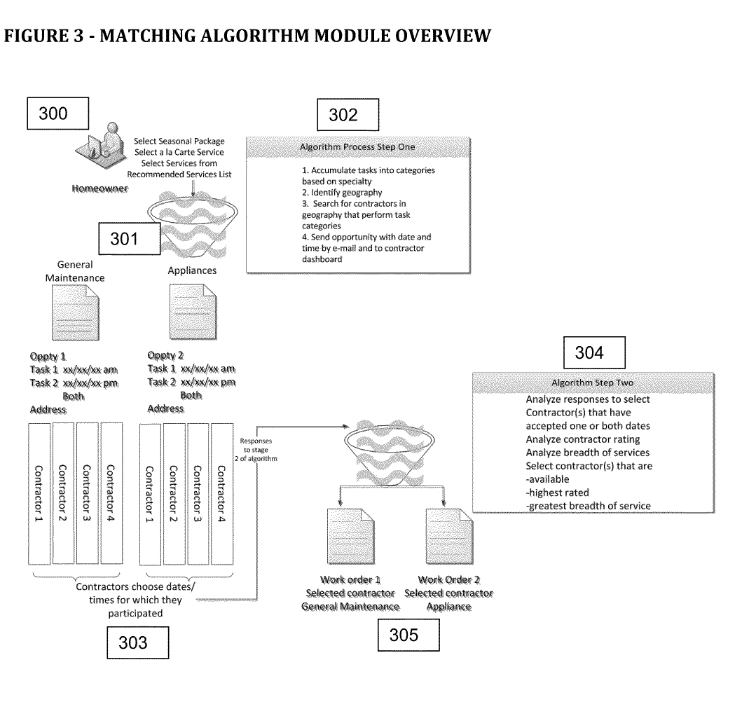

FIG. 3 depicts the overall flow of information within the service request match processor. The matching program assigns the highest quality contractor(s) that can meet the service needs of the customer. The variables in the selection process include but are not limited to: 1) dates and times selected by the customer (called a timeslot); 2) total number of visits required to complete the services; 3) quality rating of the contractors; 4) geographic location of the customer; 5) contractor availability; and 6) customer criteria ranking (highest quality, earliest service date, lowest price, preferred contractors). These variables can be optionally ranked by the customer and yield different results.

Once the user has logged into the brokering system 300 to generate a Service Request, the user selects given options for individual Service Request line item entries, or pre-determined groupings of potential tasks or recommended services. 301.

The matching program 302 then analyzes the user-provided request, using multiple criteria for determining a potential best-fit, including but not limited to the following: 1) Accumulate the tasks into categories based on the specialties. 2) Identify the geography. 3) Search for contractors in the geography that perform services in the task categories. Based on these criteria, the program sends the opportunity with timeslots to contractors and waits a preselected time period for responses. Contractors who are available for a time slot respond (303). The preselected time period is based on history of responses from contractors and number of responses received. For each time slot: a) for each contractor: calculate a score based on the rating of the contractor for each service task, the contractor pricing, the percentage of the total services they can do based on their profile, and weighted based on the customer criteria above (304); b) choose the highest score that can complete all of the service tasks in one timeslot. If all of the service tasks cannot be completed within one timeslot, then select the highest score contractor and that timeslot. Remove the service tasks that contractor is performing and repeat step 304 with the reduced service tasks. The program continues to repeat until a set of contractors and timeslots have been chosen that cover the complete set of service tasks (305).

If some service tasks are not covered, then a manual process is initiated. The system sends an electronic mail (email) to the provider of the system/method which subsequently causes a CRM (customer relationship management) system ticket and an email to be created. The email outlines: a) the Service Request in question; b) a statement informing the reader that the system was unable to meet the Customer's request; and c) an indication as to which of the items in the Service Request it was or was not able to satiate with a match from the Contractor database.

Service Order Processor and Method

The third primary component in the overall preferred embodiment is the service order processor. It interacts with the service request match processor to dynamically and automatically create a Work Order based on the best-fit matching information provided, and presents the Work Order back to the matching program for subsequent presentation to the Service Provider/Contractor through the Contractor Dashboard. The service order processor interprets service requests provided by the customer, encompassing data from the home profile database concerning the specific customer and residence, converting this data into a format for automated processing.

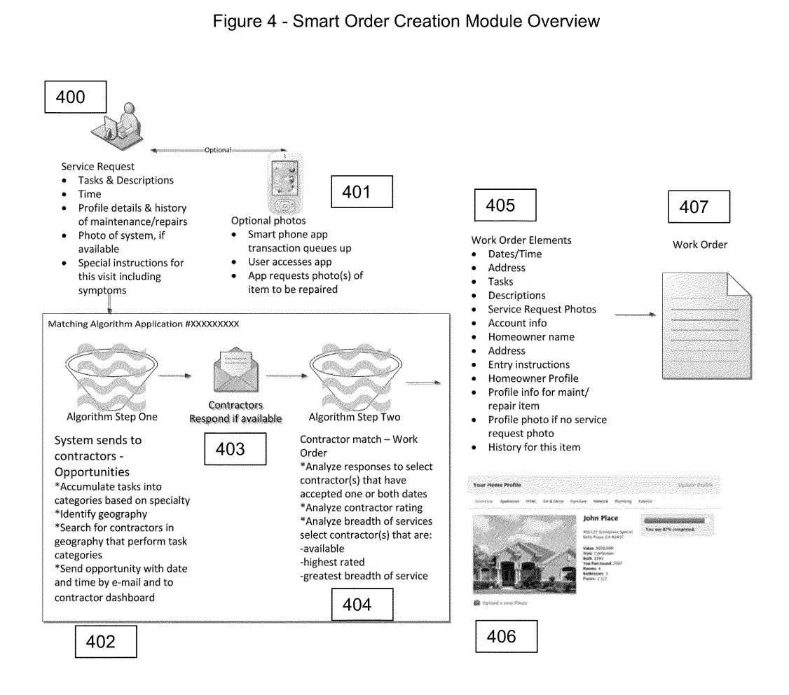

FIG. 4 depicts the overall interaction of the service order processor with the service request match processor. A Customer Service Request 400 is generated by the customer through the Homeowner Dashboard. Service Requests range from fairly simple to fairly complex. The Homeowner Dashboard contains a list of services from which the customer selects one or more options.

The customer can provide additional details to accompany the Service Request 401. This information might consist of reason for maintenance and repair, electronic photos or scanned documents that they gathered from any number of potential input devices.

The service order processor integrates with the service request match processor 402 by providing the pertinent Service Request data. The service request match processor or match processor compares request information to the Contractor Profile Database, intelligently matching requests to the available skill sets, geographic information, ratings history, and other data points. It then issues an Opportunity to one or more potential Contractors for their review/acceptance.

The Contractors have the ability to review the Opportunity 403 and can respond with an acceptance or ignore the Opportunity.

The service request match processor then analyzes contractor responses 404, and engages a decision making process for determining which of the respondents is best suited for the instant Service Request, based on both the initial static information and the dynamic Contractor information. The resulting decision prompts an interaction with the service order processor to begin the “final” Work Order generation process.

The service order processor then selects all pertinent home profile information, Service Request information, and selected Contractor information in preparation for the creation of the actual Work Order 405.

The Work Order may include a variety of pictorial representations of the parts or appliance in question, the home feature or fitment in question, warranty documents, repair history, or any graphical instructions or graphical representation of the residence that has been captured so that the Contractor has sufficient information to effectively perform the required tasks 406.

The output of the order creation process is the final Work Order 407 which is then presented to the Contractor via the Contractor Dashboard for online viewing and/or offline hardcopy printing. The customer Service Request is also updated to reflect the resulting Work Order becoming finalized, showing Contractor information, confirmed/scheduled on-premise dates/times, and any other dynamic information that may have been gathered in the Contractor selection or Work Order generation process.

Work Order Creation and Completion Workflow

In a preferred embodiment, the service order processor provides for customer work request criteria modifications/enhancements throughout the process that will result in on-the-fly work order revisions. Both Customer and Service Provider/Contractor inputs are part of the creation and modification process. Customer and Service Provider/Contractor responses and overrides are utilized to determine final assignments, scope, and timing for the actual work to be performed. The work order may be canceled by the Customer, Service Provider/Contractor, or the broker-system staff members. The Service Provider/Contractor may opt to turn down a service request.

A preferred embodiment allows for subsequent work order variations based upon the original work order, spawning child service requests from a parent work order, and spawning child work orders from the parent work order based on empirical data discovered during the initial service call. This preferred embodiment allows for work orders to be subsequently completed, or canceled, or placed in a hold state in the event that a child work order is spawned from the original.

Once the service is complete, the system requires completion of the work order and its data entry into the repair or maintenance history where it is combined with prior history and is available for the next service request.

Brokering System Design Overview

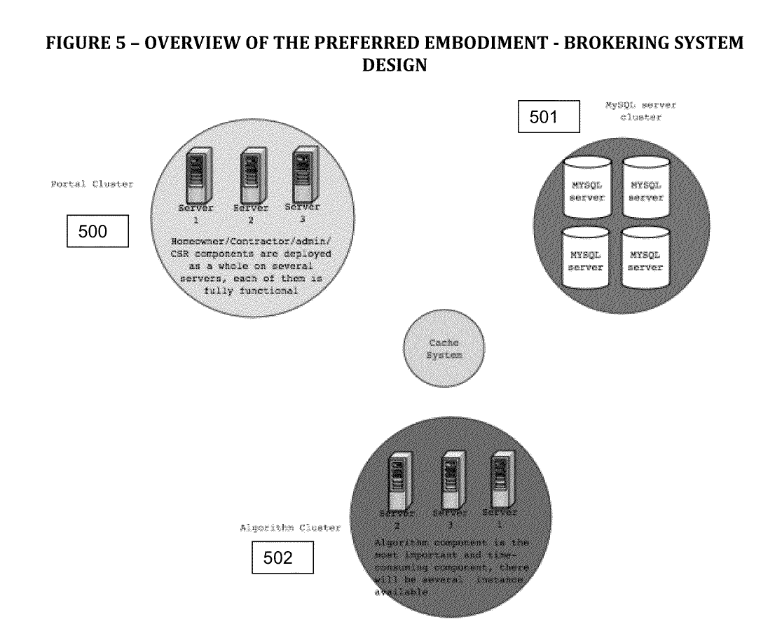

FIG. 5 depicts the system design of the major subsystems that make up the brokering system of a preferred embodiment.

Portal Cluster 500—The system design has a group of user portals, or Dashboards, for the various customer, contractor, and staff users to interact with the brokering system. The portal cluster is the web interface that customers and service providers/contractors use, and is manifested in the form of the Customer Dashboard user interface, the Contractor Dashboard user interface, and the Staff Dashboard user interfaces.

Database Server Cluster 501 is a preferred embodiment of one or more database servers optionally deployed in a MySQL environment, where the database and data tables can be partitioned across several servers.

Logic and Program Cluster 502 is one or more servers to support the application system code, programs, and logic that make up the brokering system in a preferred embodiment.

Brokering System Architecture

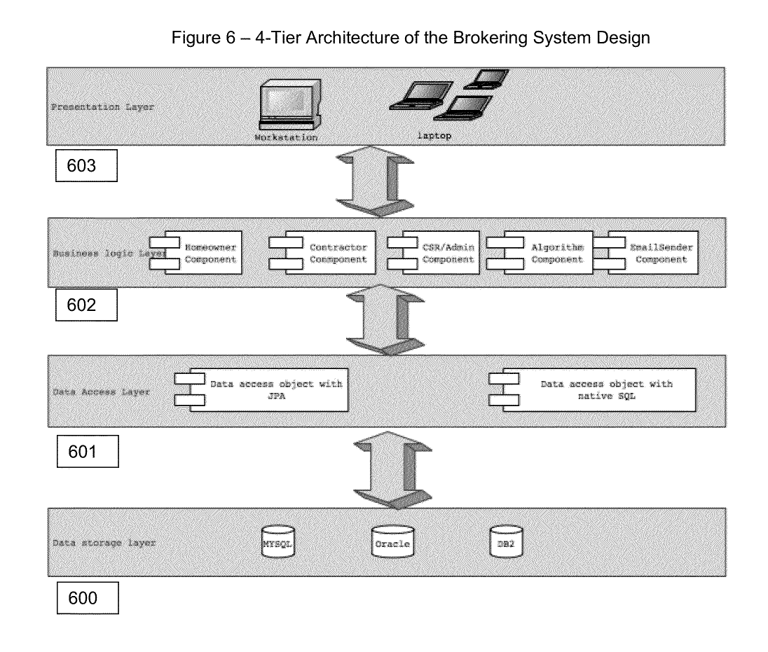

FIG. 6 depicts the 4-tier architecture of the overall brokering system design. Tier 1 600 of the architecture is the physical storage layer. Here at least one physical server resides, containing the database(s) and data files employed within the brokering system per a preferred embodiment.

Tier 2 of the architecture 601 is the data access and data abstraction layer, where database access routines are deployed to provide a bridge from the software applications and business logic to the physical database files.

Tier 3 of the architecture 602 is the business logic layer. It contains all application software, programs, workflow, and data flow logic for the brokering system in the preferred embodiment.

Tier 4 of the architecture 603 is the presentation layer. It encompasses all user interface related code including the various user portals or user dashboards, and graphical representations of data/information found in the brokering system per the preferred embodiment.

Brokering System User Interaction

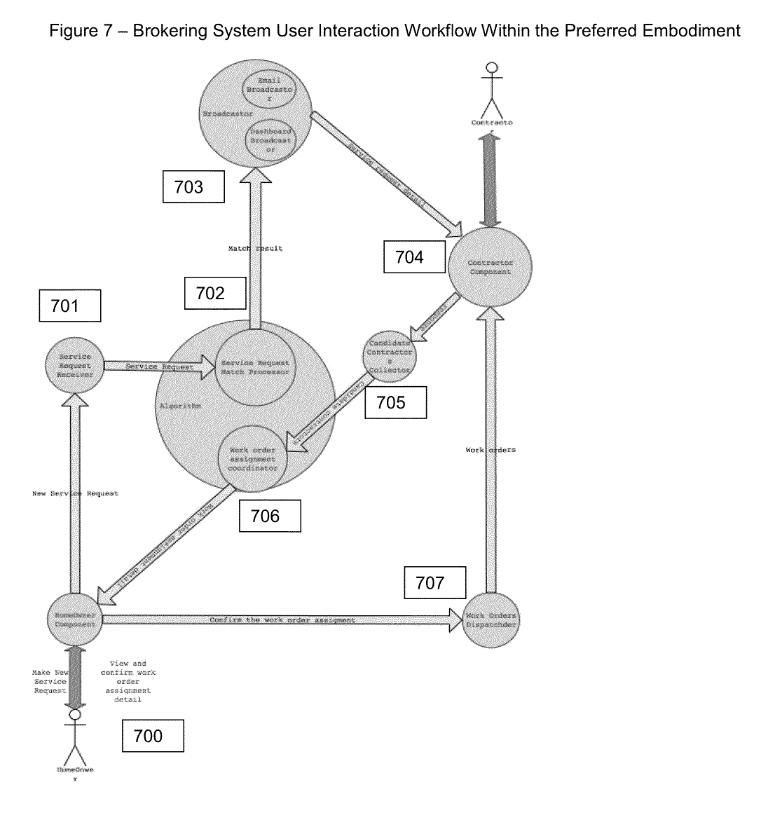

FIG. 7 depicts the typical user interaction and data workflow through the various components of the brokering system in the preferred embodiment. The Homeowner Dashboard component 700 provides an interface for the Customer to interact with the brokering system. A customer can enter a Service Request that is then received and processed by the Service Request Receiver component 701.

The Service Request Receiver processes and passes along the Service Request information to the service request match processor 702, where the request is analyzed and intelligently compared with the Contractor Profile information, resulting in a short list of potential contractors who are best suited to the Service Request at hand.

Once the matching program has selected a short list of potential Contractors, the broadcaster component 703 dispatches the Opportunity (potential Work Order) to the selected short list and makes this information available through the Contractor Dashboard.

The Contractor Dashboard component 704 provides the Opportunity information to the selected Contractors. The Contractors can acknowledge/accept the Opportunity via the Contractor Dashboard.

The candidate Contractor collector component 705 receives the request from the Contractor Dashboard, processes it, and passes the pertinent information to the matching program's Work Order assignment coordinator 706.

The Work Order detail is then passed back to the Homeowner Dashboard 700 so that the Customer can access confirmation information on the anticipated service date and accept. The Work Order is then officially issued via the Work Order Dispatcher component 707, and ultimately the Contractor receives the final Work Order via the Contractor Dashboard component 704.

Home Profile Workflow

The home profile database allows customers to create and manage their residence profiles.

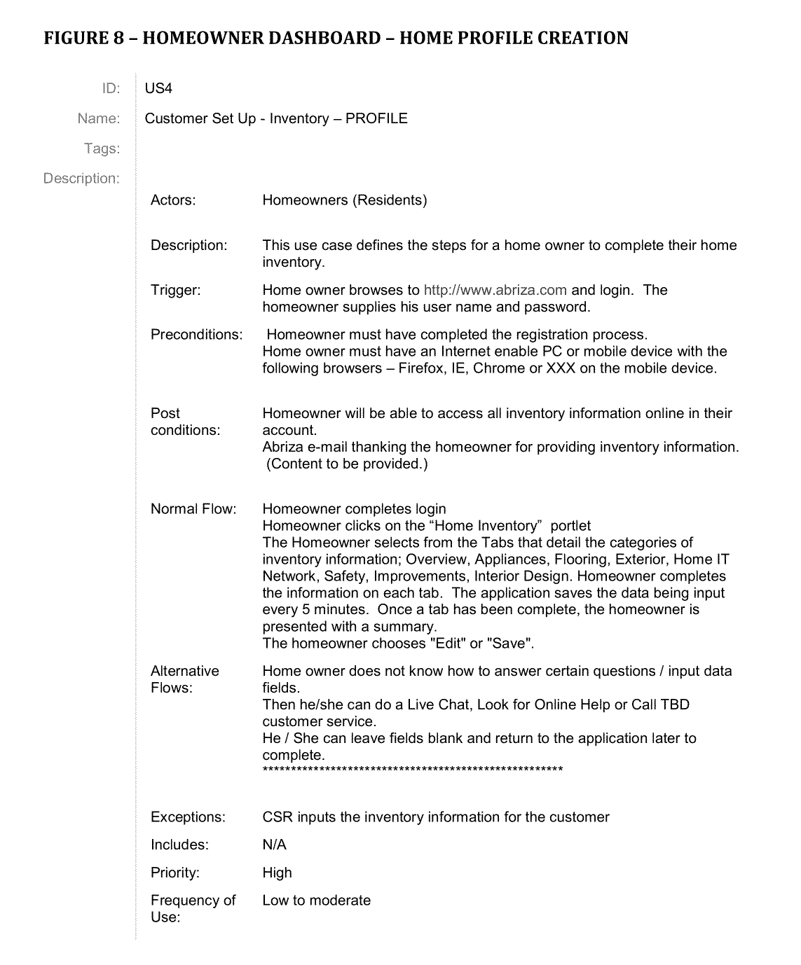

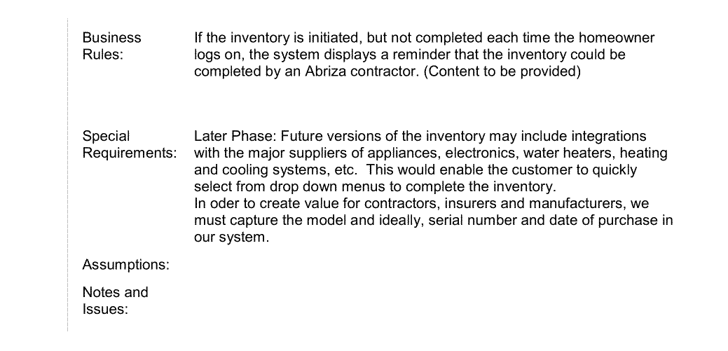

FIG. 8 shows the workflow for the initial creation of the home profile.

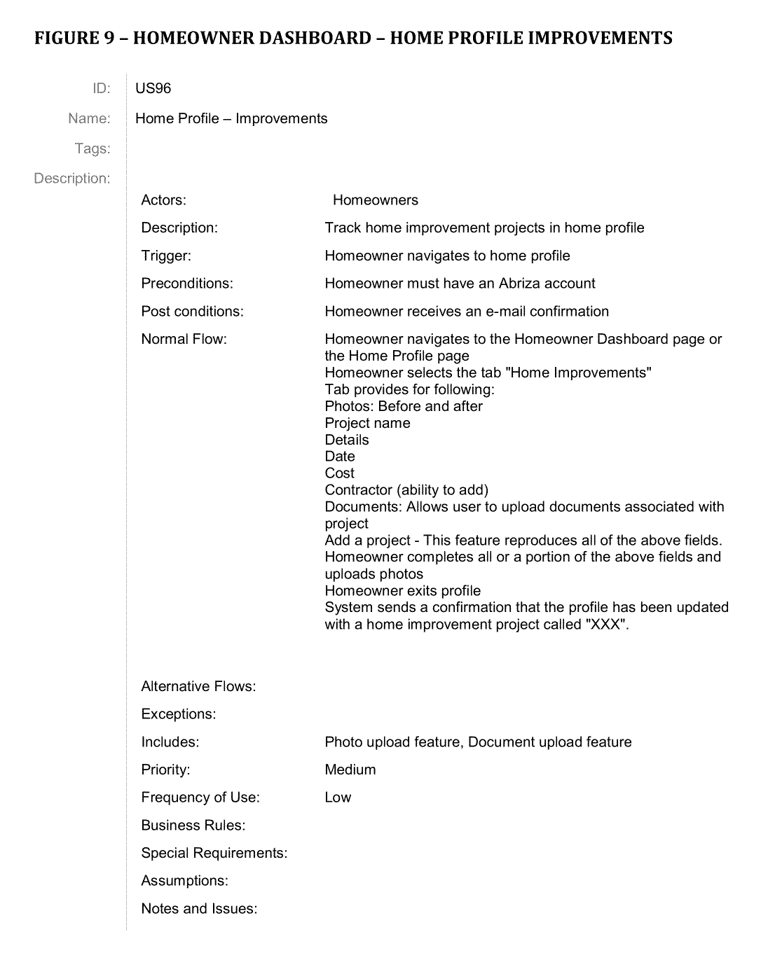

FIG. 9 provides a detailed workflow of the customer's options for modifying and improving the home profile to keep the residence history up to date with changes and modifications. These options accommodate before and after photos and associated documents so that a repair history is maintained.

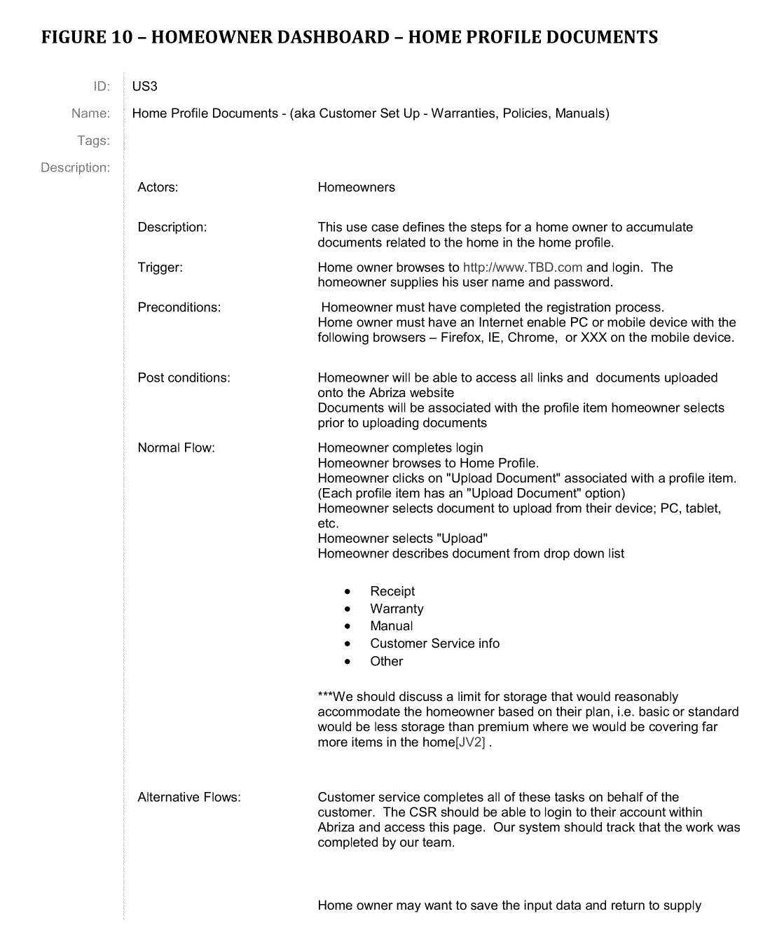

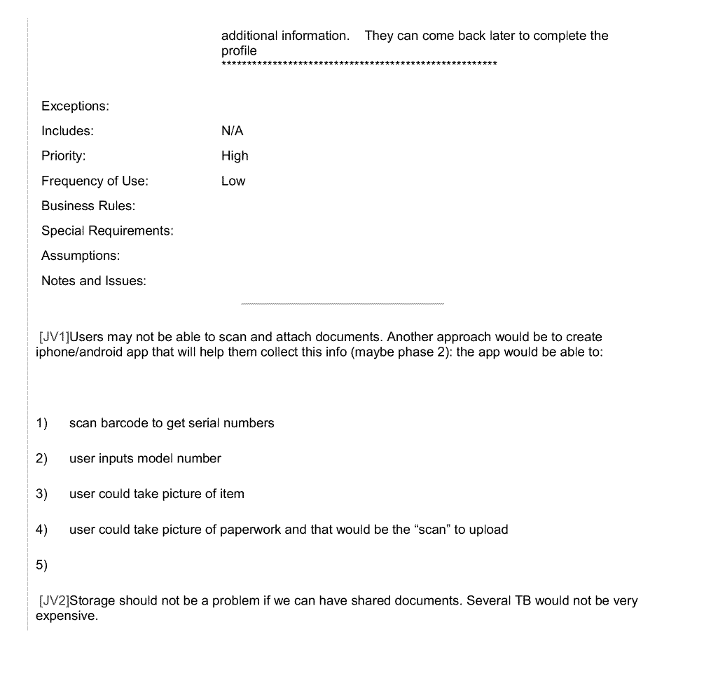

FIG. 10 describes the detailed workflow for the customer's ability to add pictures, documents, receipts and other historical records to the home profile database so that a historical repository may be maintained over time.

Additionally, a customer has the ability to request historical reports and informational queries as noted in FIG. 2.

Service Request Process Workflow

The Customer accesses the Homeowner Dashboard by keyboard, mouse, touch screen, voice command receiver, etc., in order to initiate a service request.

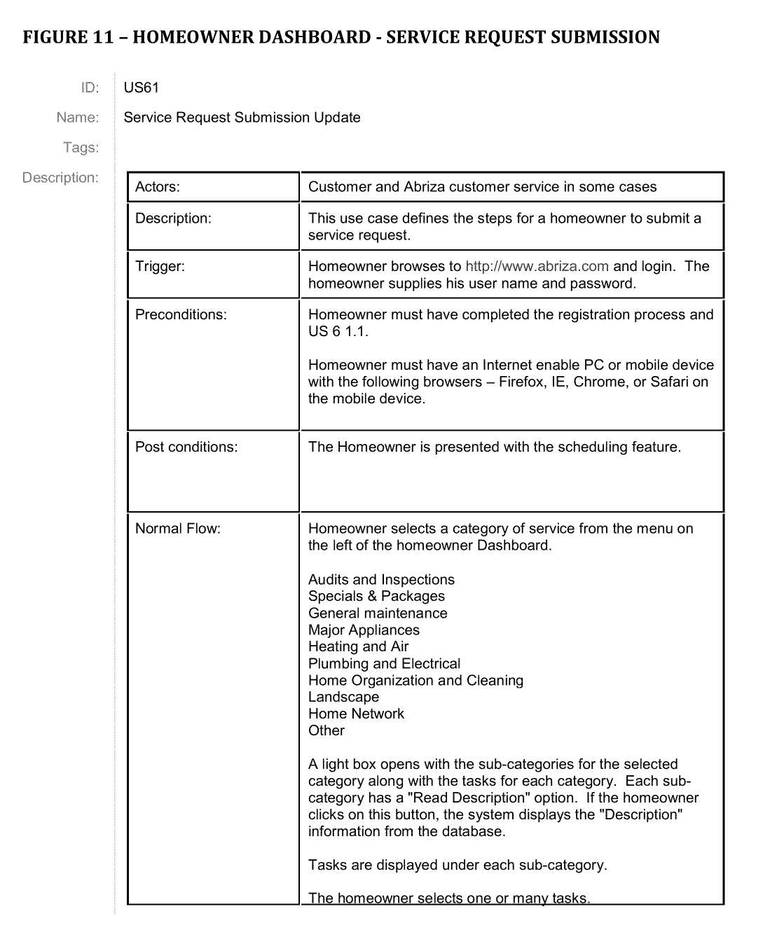

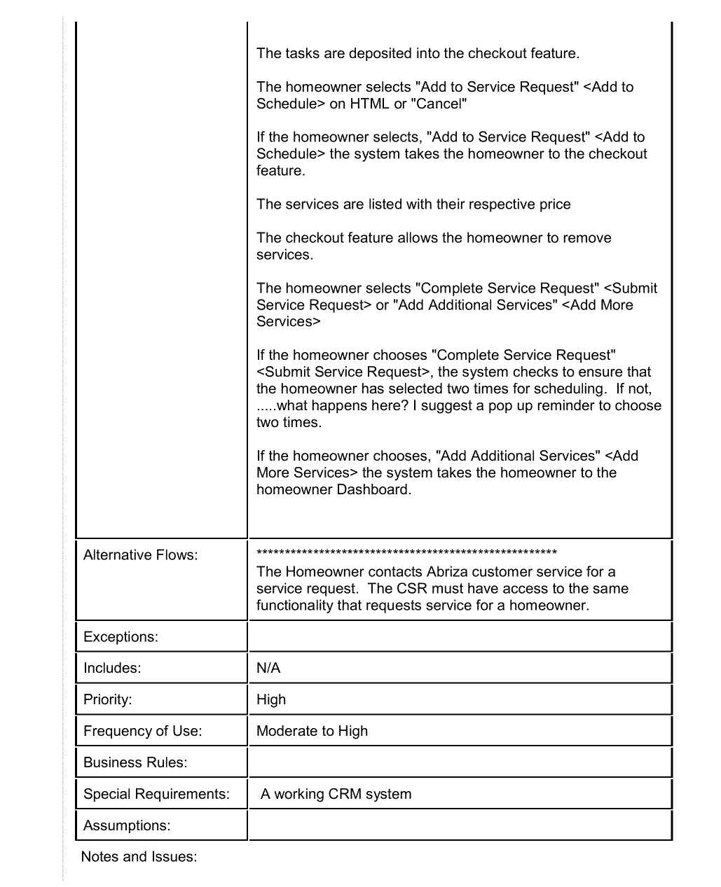

FIG. 11 provides a detailed workflow of the Service Request process. The user has the option of selecting from pre-defined, individual service request items via the a la carte menu, or of selecting a Seasonal package of pre-defined service request items that have been bundled together based on suitability for a given seasonal inspection and maintenance visit by the Service Providers.

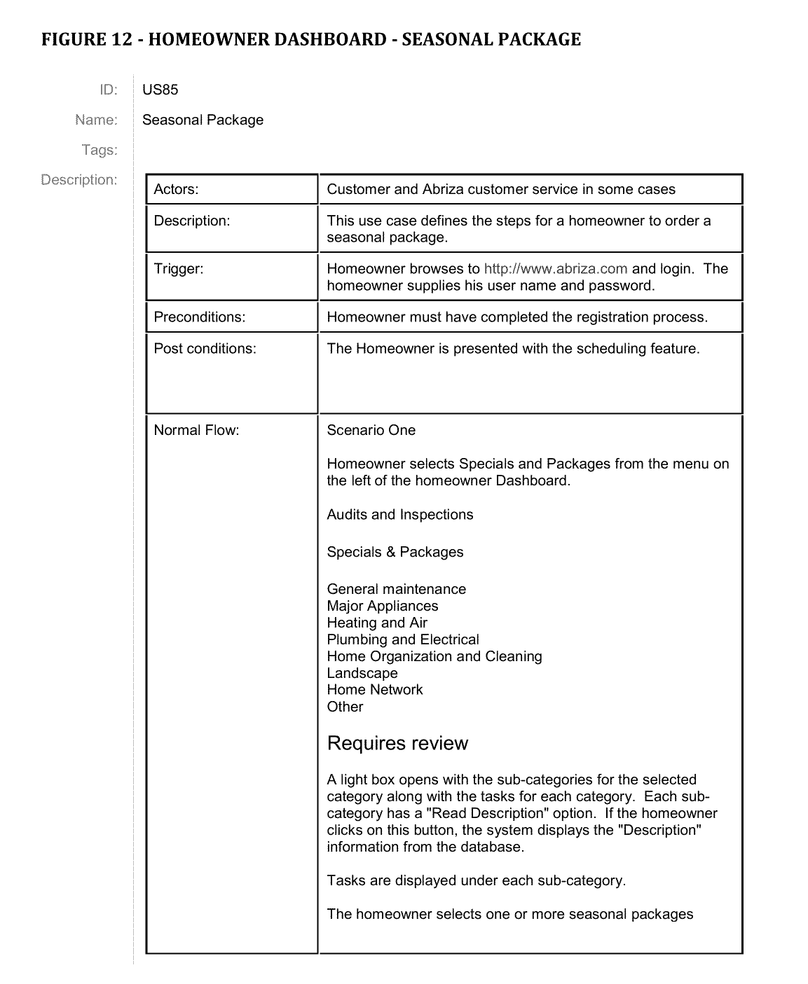

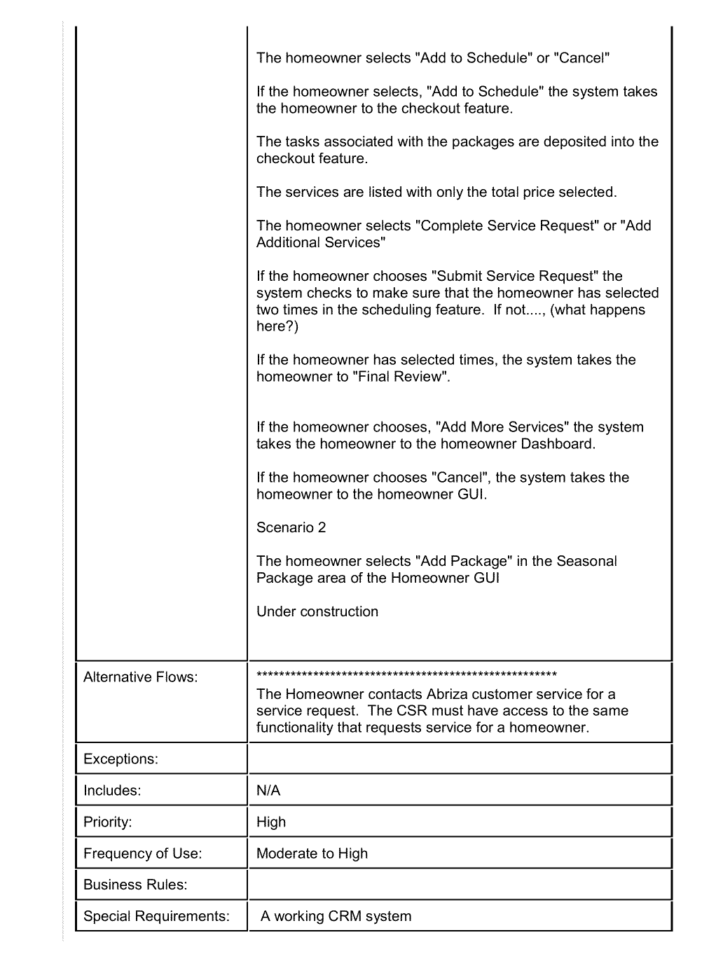

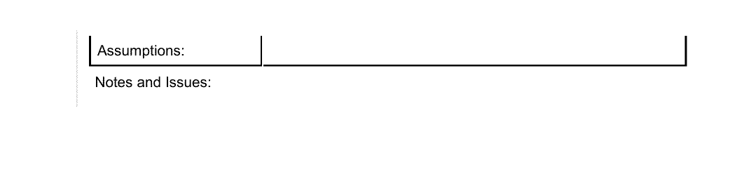

FIG. 12 outlines the workflow for the Seasonal Package selection process and user experience.

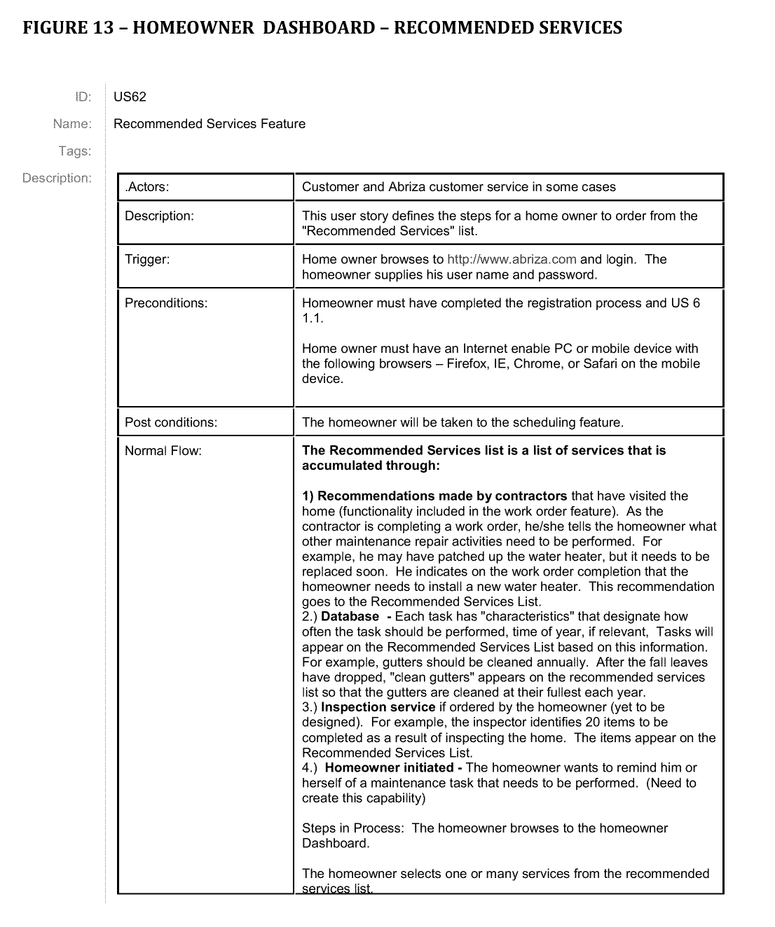

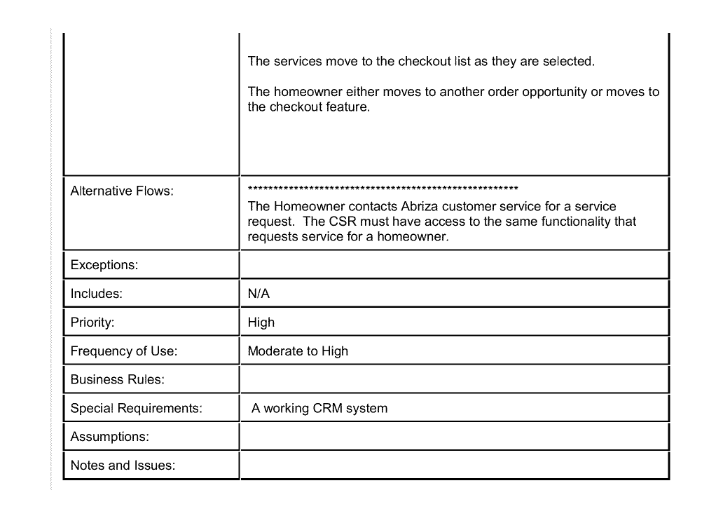

FIG. 13 outlines the workflow associated the Customer optionally selecting from a list of pre-populated service request suggestions generated by the system.

Matching Program Workflow

The service request match processor processes information from the Service Request, comparing and contrasting that info with the available Service Provider/Contractor profiles, and determining a best fit(s) for the targeted service requirements.

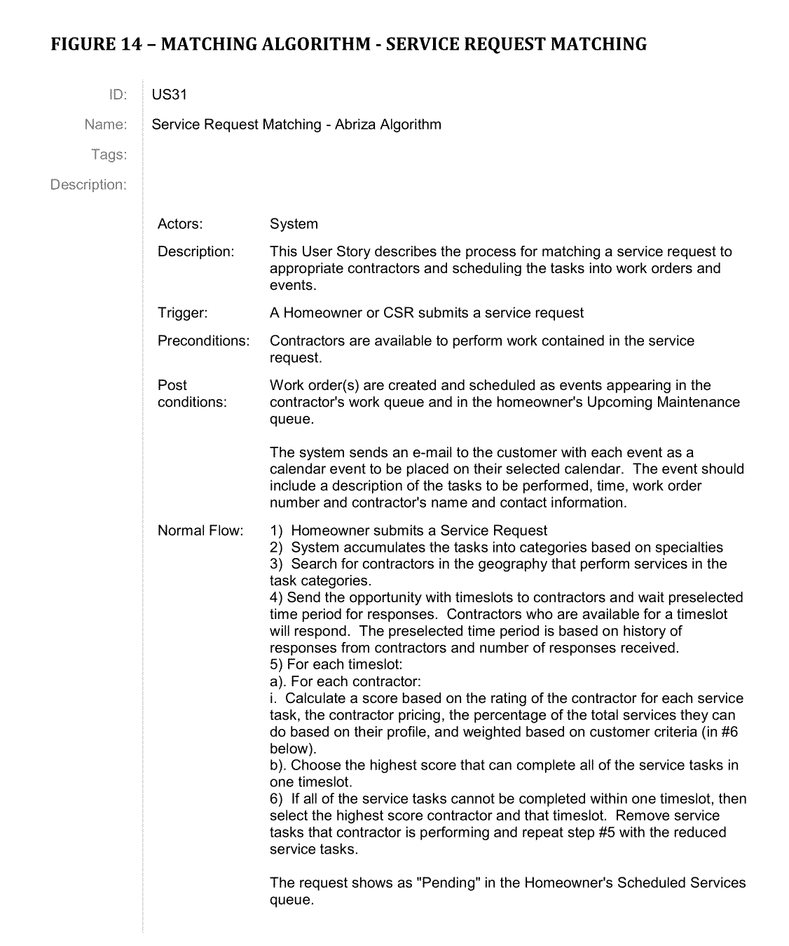

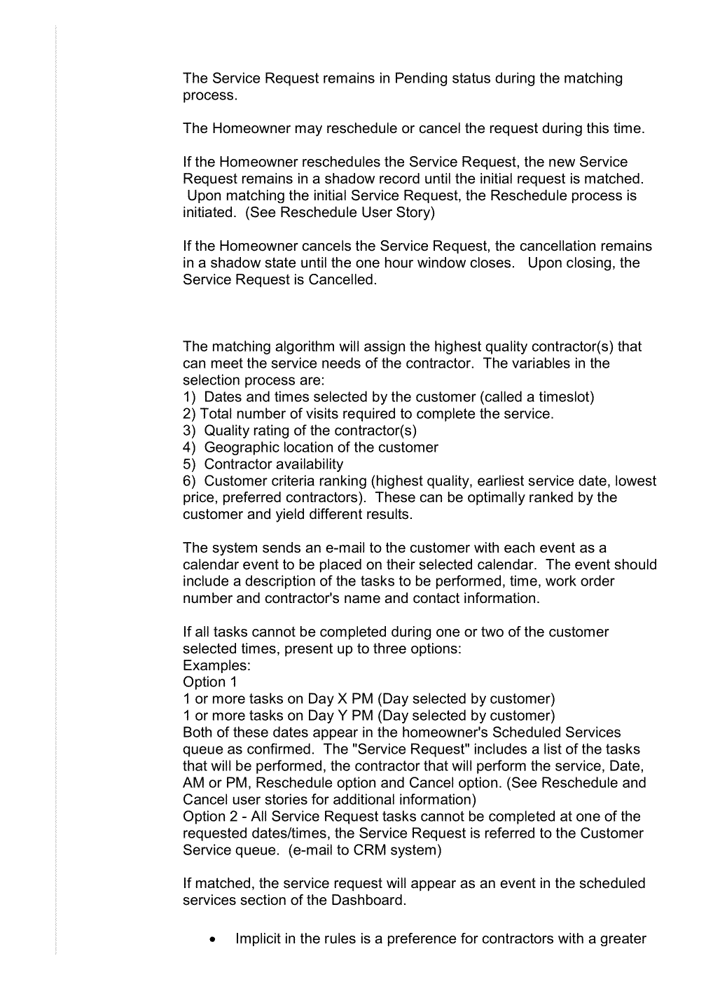

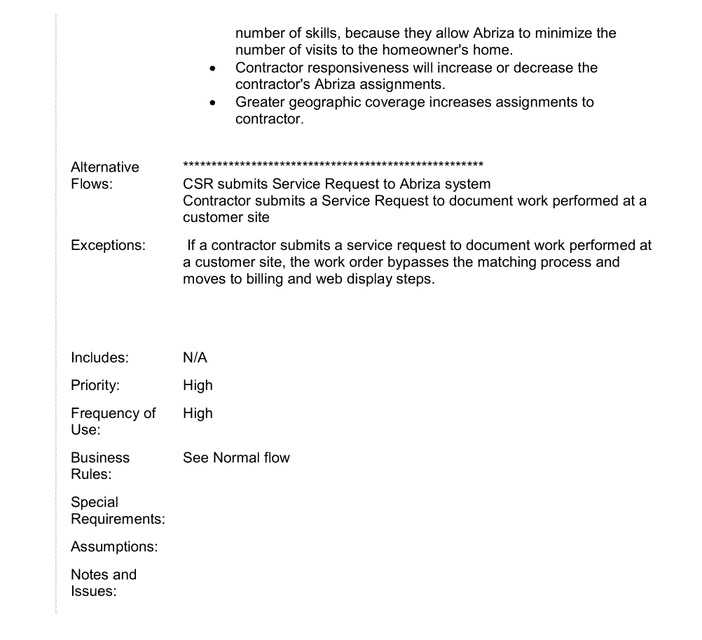

FIG. 14 outlines the workflow for the matching program. It delineates the normal process flow as well as exception condition handling for Customer cancellations, or potential lack of matching service providers for the Customer's specific needs based on the information available.

Work Order Creation Workflow

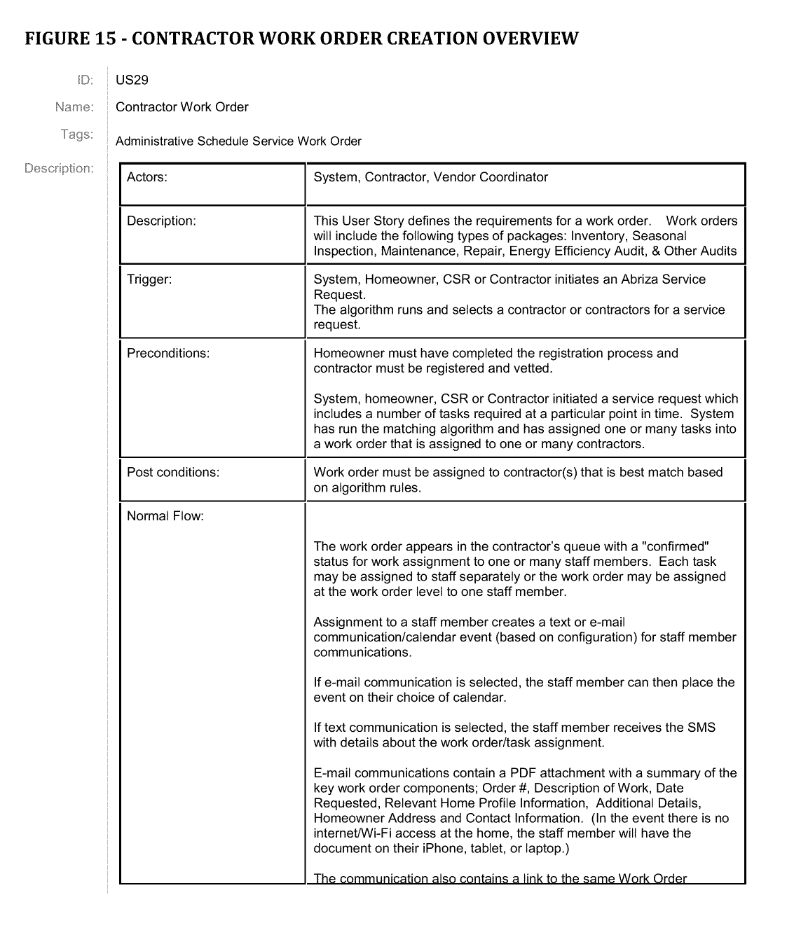

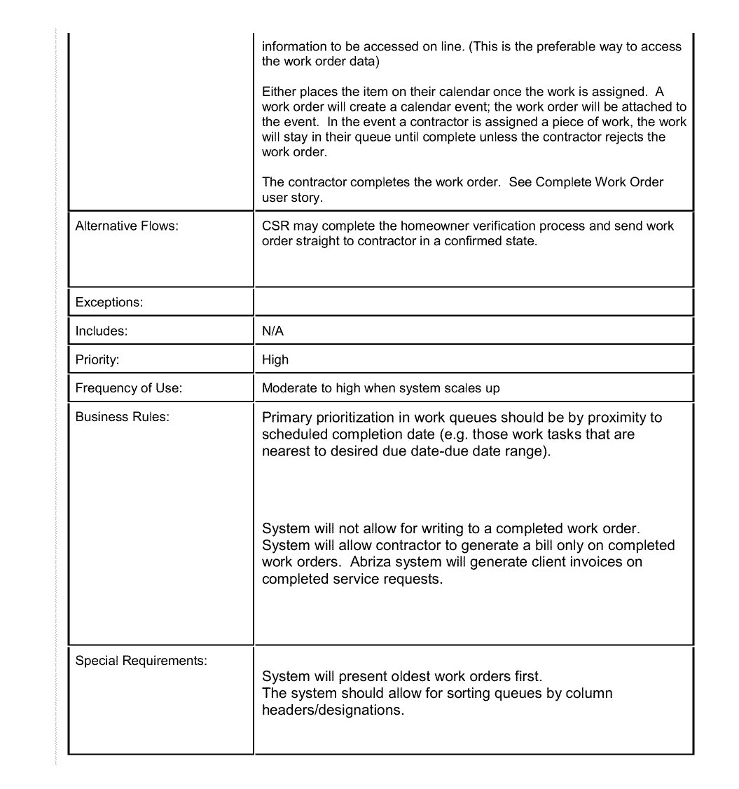

FIG. 15 outlines the workflow for the creation of a Work Order within the system. The service request match processor prepares a selected set of possible Contractors, and handles the iterations that are possible with certain Contractors opting to accept or pass on the Opportunity. Once the Contractor(s) accept(s) the Opportunity, the matching Program works in tandem with the service order processor to produce a formal Work Order. That Work Order is then passed along to the selected Contractor.

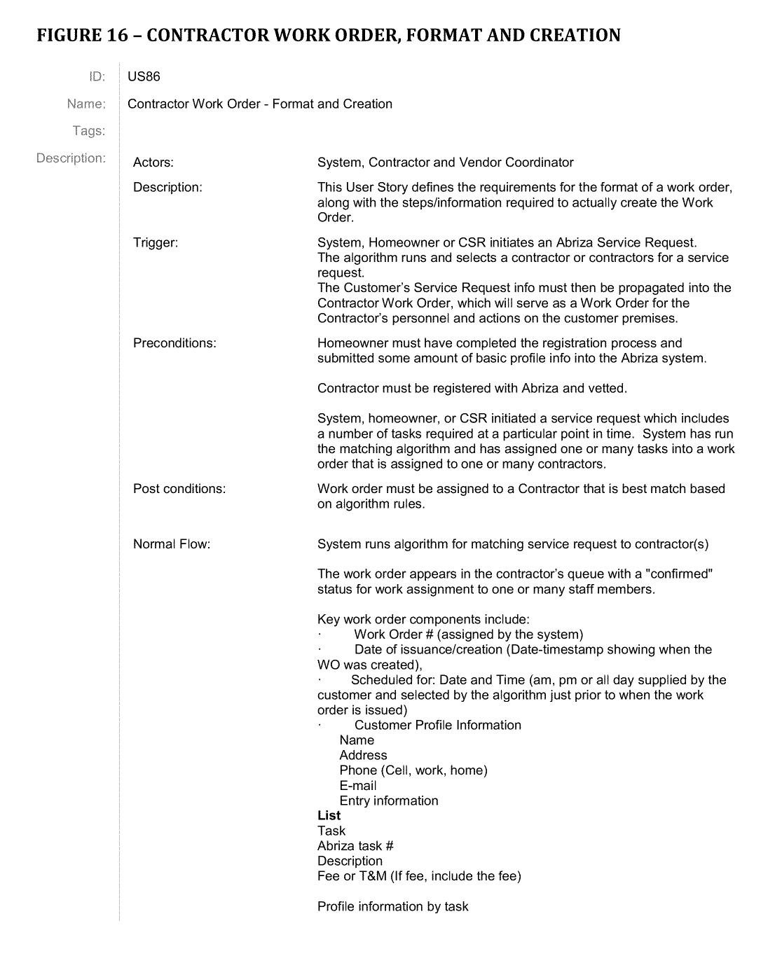

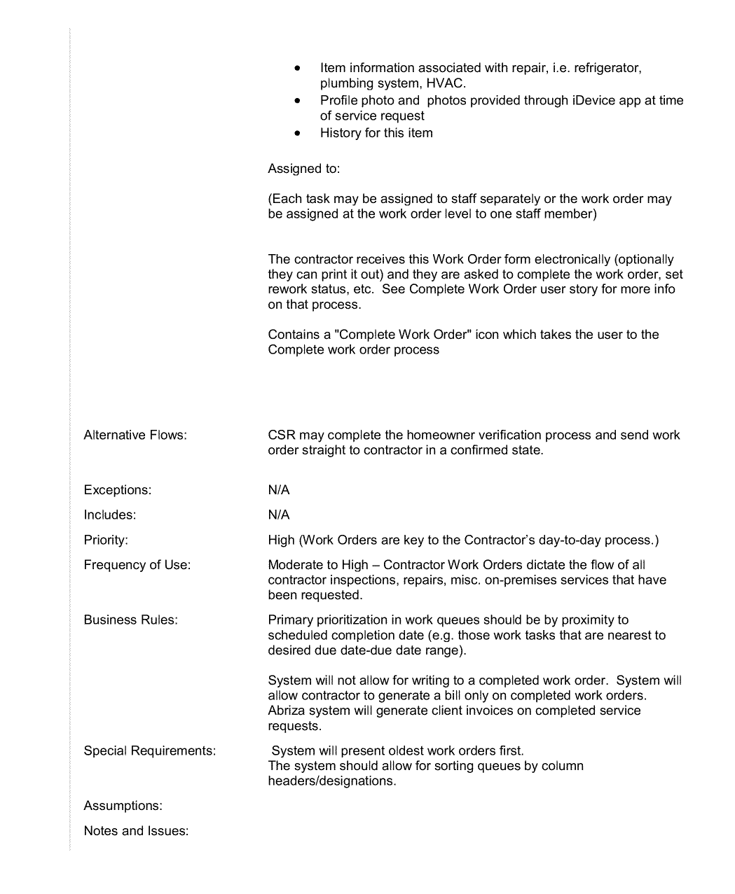

FIG. 16 outlines the workflow and format for managing the Work Order that will ultimately be generated and passed to the Service Provider/Contractor.

Work Order Completion Workflow

Work Orders may be completed when the Contractor(s) have finished all Customer-initiated Service Request line items that embody that Work Order and the Contractor has completed data entry.

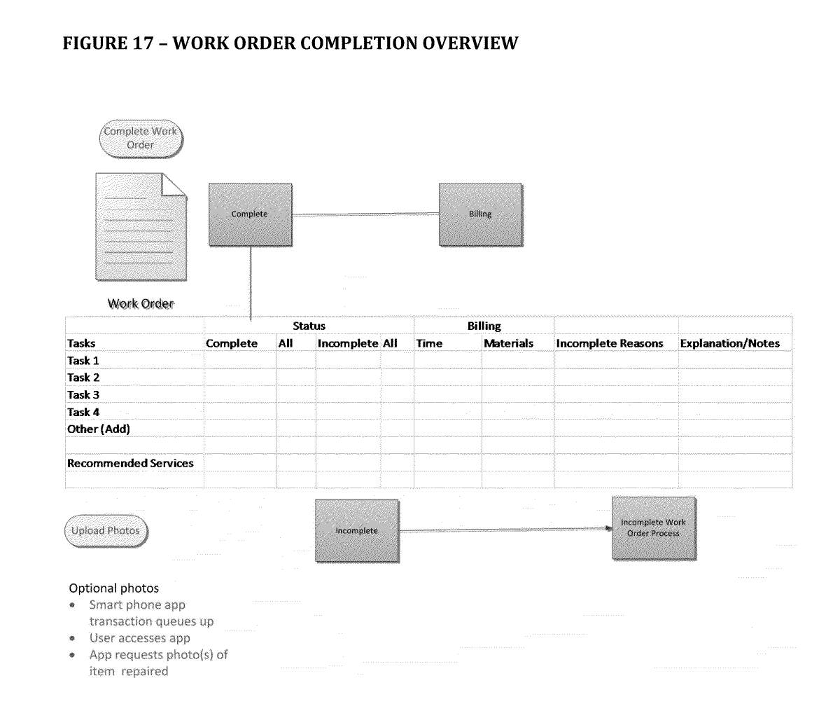

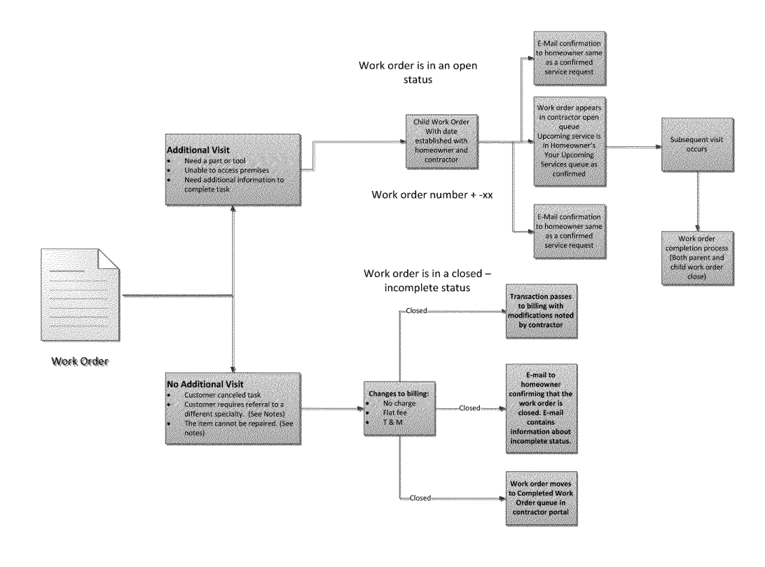

FIG. 17 is a schematic overview of the Work Order Completion process. This overview shows how the Work Order may be held in an incomplete state to accommodate various delays in the actual work product or on premises scheduling.

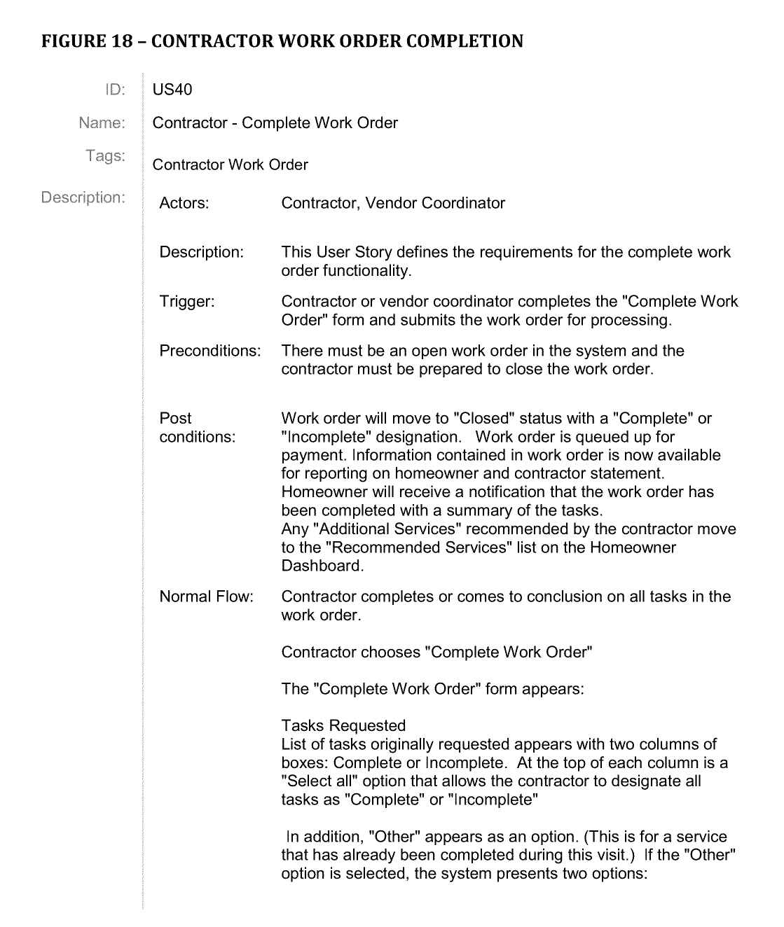

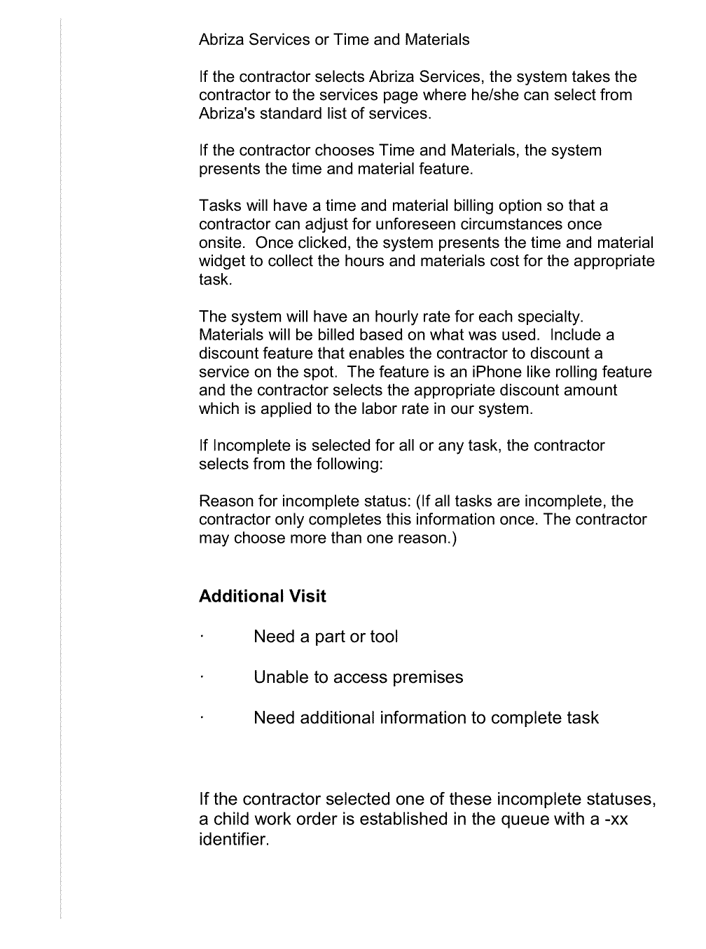

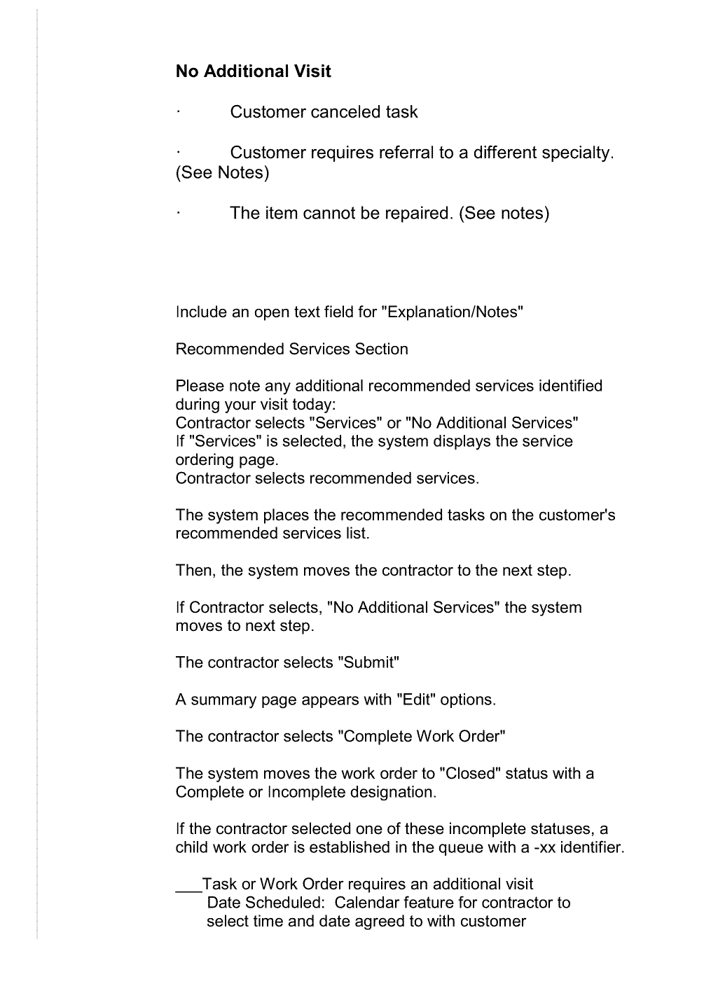

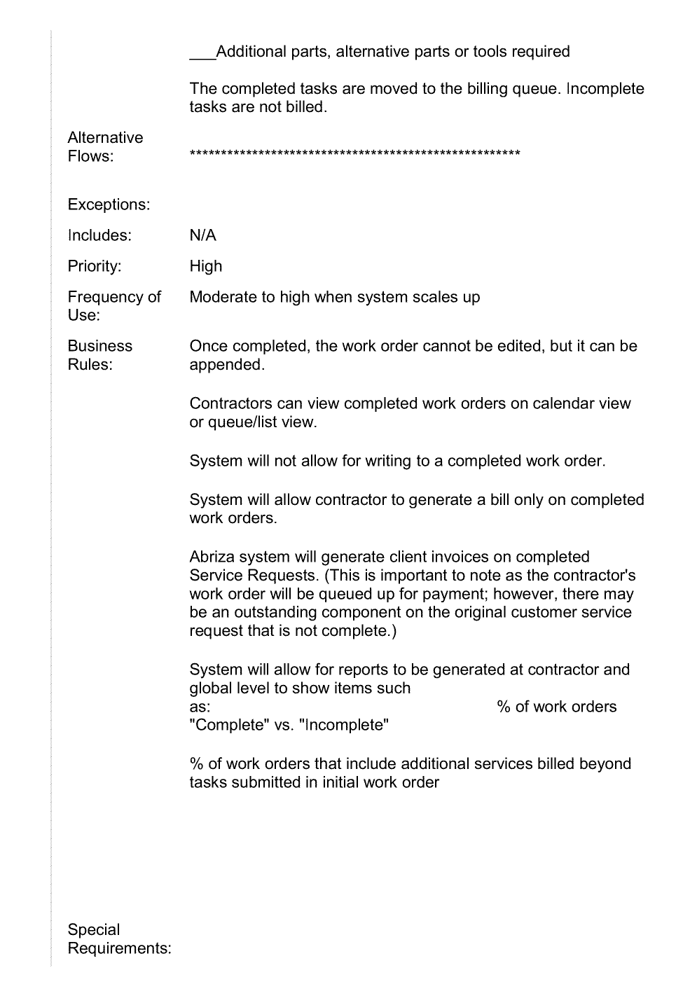

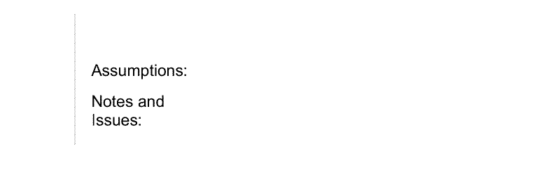

FIG. 18 is a detailed schematic of the process workflow for closing out a Work Order. This process includes options for closing out the Work Order in a Complete or Incomplete status and options for subsequent child work order generation for these ongoing services to be performed at the same residence.

The disclosed system and method for intelligently generating work orders schedules and combines customer service requests, customer profile information, service provider profile information, service provider ratings and historical information, and dynamic information related to scheduling and availability within a desired timeframe and based on a variety of variables that can be prioritized by the customer.

In a preferred embodiment, the service transactions transpire between various parties depending on local conditions and use cases. These include the end-user customers, Property Management companies, Service Providers/Contractors, and staff from the brokering system provider company. Optionally, other embodiments employ fewer or greater user types, or may refer to them in other terms or naming conventions. The system and method optionally involve different types of customer service requests that do not involve homes, residences and associated repair items. Critical data elements of the home profile database feed the programs and decision making processes inherent in the disclosed method.

Additional functionality that is optionally incorporated into the disclosed system and method includes, but is not limited to: 1) Marketplace: within the home profile, there may be a marketplace that provides quotes on various competitive prices for items that are reaching their expected end of life. This feature assists the homeowner in making a transition to a new appliance or component before is failure. 2) Investment tracking for tax purposes: in the provider database is information that assists the homeowner with determining the tax basis on the property upon sale. A program extracts appropriate information from the database, and the information is made available to homeowners for computing taxes in a module that tracks investments. 3) Automated warranty management: The disclosed system and method collects information on all home and appliance warranties including the effective and ending dates of the warranty. Not only does this system communicate the information to the manufacturer, it also administers the warranty on behalf of the customer ensuring that the customer does not pay for replacement or repair of an item that is already covered by a warranty. The provider of the system/method can be the intermediary between the homeowner and the warranty provider.

Also included in the home profile module are any similarly functioning modules derived from infrastructure, features and components found in another setting. Alternative embodiments may use alternative dynamic inputs to match a requestor with a provider based on a different prioritized set of variables.

The provider of the disclosed system/method accumulates information about residential homes and other living spaces. This information itself, with or without identification of the homeowner or specific addresses, is of value to various participants in multiple markets. An additional embodiment of the disclosed system and method is the segregation and analysis of this information to aid decision-making purposes. Nonlimiting examples follow: 1) Total cost of home ownership—using information about the energy efficiency or lack thereof, the provider of the system/method will estimate the total cost of ownership including energy usage. This will help appraisers and buyers make more informed decisions about the overall value and cost of the property. The information will also be used to incentivize homeowners to invest in energy efficiency measures to save money. 2) Provider Score—the provider of the disclosed system/method may develop a “Provider Score” that takes into consideration improvements, energy efficiency investments, and proactive maintenance of a home. This score can be used by various interested marketplace participants to make better decisions about the home including, but not limited to, purchase, appraisal, insurance marketing, and investment.

In other embodiments, the invention includes alternatives for the service order processor that include a similarly functioning method or process which pulls a subset or different data elements and information from the home profile database. The service order processor may be integrated with the service request match processor in a different manner, drawing upon a subset of the available Service Provider/Contractor profile information. The resulting Work Order may consist of a subset of the overall information provided to Service Providers/Contractors in a preferred embodiment.

In other embodiments, critical data elements of the Service Provider/Contractor database and rating system, which feed into the service request match processor, may be modified or excluded. Those skilled in the art recognize that this may result in different matches between the service request and the service provider. Other databases, or lists, or information repositories may be substituted in lieu of the Service Provider Profile module.

In a preferred embodiment, critical decisions and data elements of the service request match processor feed into the service order processor, allowing for intelligent selection and matching of the customer's desired service request with the abilities, price, availability, and geographic limitations associated with the network of Service Providers/Contractors. In other embodiments, various subsets of the Service Provider/Contractor Profile may be employed in the matching program.

A preferred embodiment is designed for transactions over the internet, with specific portals matching the user profiles: Customer, Service Provider/Contractor, brokering system provider Staff. Additional variants or embodiments may be implemented where the invention is not reliant upon web browsing or internet usage. Conveniently, the invention can be subsumed into a proprietary software suite (e.g. Customer Relationship Management system or Content Management System), or adapted to run in a terminal server environment connected to a host system.

In other embodiments, the disclosed system and method may be implemented in a variety of technical environments. It can be coded in various commercially available programming or scripting languages. It can be ported to different commercially available operating system environments. It can be implemented to work with the help of various supporting code libraries and utility packages from various software suppliers who provide commercially available tools for the selected operating system and programming language(s). It can be designed to employ various commercially available databases which will serve as information repositories for the content provisioning aspects.

The invention also includes any of available devices used to access the overall system. These computing devices are used for data entry and selection of choices. These devices may be used for requesting information such as work orders, historical reports, or real-time queries from the system. Access devices include desktop PCs, laptops, notebooks, tablets, smartphones, printers, or other then-current-technology internet-connected devices. The invention is access-device-independent and the work order results obtained from the invention may be presented in multiple formats on multiple device types, including but not limited to desktop PCs, laptops, notebooks, tablets, smartphones, printers, or other then-current-technology internet-connected devices.

Additional embodiments may employ additional intelligent data feeds from other types of “smart home” devices or “smart appliances”. These “smart home” and “smart appliance” devices and systems include, but are not limited to, security systems, fire detection and prevention systems, electrical power monitoring systems, natural gas metering and monitoring systems, air quality monitoring systems (e.g. radon, carbon monoxide), water monitoring and metering systems, automated landscape sprinkler systems, pool/spa control systems, stereo/audio/video control systems, intercom and telecom systems, intelligent refrigeration or cooling units, intelligent stoves/cooking devices, intelligent washing/cleaning/drying systems, intelligent HVAC control systems, and home computing network control systems.

Included in the invention are additional “smart home” and “smart appliance” devices and systems incorporated into variants and different embodiments that result in work product that differs slightly in content, scope, volume, performance characteristics, or quality from that outlined in a preferred embodiment disclosed herein. However, these embodiments in essence would provide the same unique, intelligent, work order creation process and methodology contained in the invention.

Additional embodiments may also involve different target markets, other than the home services niche. This could be any service provisioning application, where customer requests and customer profile information are compared/contrasted to an available database of service providers and associated vetting/rating information, and work orders are automatically generated to effect the appropriate services provisioning. Examples include, but are not limited to, computer repair services; automobile repair services; gardening, lawn care, and landscaping services; subsets of, or niches within, the home services market, such as appliance repair services; physical health maintenance and profile; and other professional services (legal, medical, dental).

In the foregoing description, if various features are grouped together in a single embodiment for the purpose of streamlining the disclosure, this method of disclosure is not to be interpreted as reflecting an intention that the claimed embodiments of the invention require more features than are expressly recited in the claims. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

1. A computer-implemented home maintenance and service system comprising:
a) a customer portal interface, a service provider portal interface, and a system provider interface, each portal interface configured to input data and receive data via keyboard, mouse, touch screen or voice processor;
b) a home profile database storing customer information and a home profile of all home related information;
c) a service provider database storing service provider information;
d) a service request match computer processor in communication with the home profile database, the service provider database, and a service order processor, the service request match processor programmed: to receive a service request for a home from a customer through a customer portal interface and obtain a home profile from the home profile database, to compare the service request and home profile to the service provider database and select at least one best fit match of a service provider for the service request, and to communicate service request and service provider information with the service order processor; and
e) the service order processor in communication with the home profile database, the service provider database, and the service request processor, the service order processor programmed: to communicate service request and service provider information with the service match processor, to prepare, change, and close out a work order for the service request, and to communicate work order information with a customer and a service provider.

2. The system of claim 1, wherein the home profile database includes purchase, maintenance, repair, improvement, infrastructure, appliances, decorative appointments, exterior, interior design, home network, and safety devices information; diagrams, as-built drawings, plan drawings, appliance manuals, user manuals, photographs, warranty documents, home system characteristics, requiring maintenance, home appliance characteristics, updates, history of service requests, in-process work orders, or completed work orders or combinations thereof.

3. The system of claim 2, wherein updates include an update of the home profile database with completed work order information provided by a service provider upon completion and close out of a work order for a service request.

4. The system of claim 2, wherein the system accepts data feeds from home devices and home appliances.

5. The system of claim 1, wherein the service provider database includes service provider contact and profile data, skill sets, geographical proximity, licensing, insurance, references, ratings, or historical information of customer satisfaction with past performance or combinations thereof.

6. The system of claim 1, wherein the customer information includes user name, contact information, address, and payment method.

7. The system of claim 1, wherein the system outputs through the customer portal interface a list of service options to the customer and allows the customer to provide input for a service request through the customer portal in response to the service options.

8. The system of claim 1, wherein the home profile database provides a query and reporting function the user may access through a user portal.

9. The system of claim 8, wherein the reporting function outputs at least one type of report that describes maintenance, repairs, and improvements to a home.

10. The service request match processor of claim 1, wherein the service request match processor is programmed to select at least one best fit match of a service provider based on variables including dates and times selected by the user, total number of visits required to complete the service request, quality rating of the service provider, geographic location of the user, service provider availability, or user criteria ranking or combinations thereof.

11. The service order service order processor of claim 1, wherein the service order processor is programmed to interact with the service request match processor to create a work order based on best fit matching information determined by the service request match processor, and presents the work order to the service request match processor for subsequent presentation to the service provider through a service provider portal.

12. The system of claim 1, wherein the system further comprises a database server cluster of database servers; and a logic and processor cluster of servers for the service request match and service order processors, and application system code and logic used therein.

13. A computer-implemented home maintenance and service method comprising:
a) requesting a service request for a home by a customer through a portal interface of a computer-implemented home maintenance and service system, the portal interface configured for data input and data output by keyboard, touch screen and mouse;
b) receiving the service request through a match computer processor, the match processor programmed to combine the service request with customer information and a home profile obtained from a home profile database, the home profile database storing customer information and a home profile of all home related information;
c) comparing the service request and home profile to a service provider database through a matching program executed by the match processor, the service provider database containing service provider profiles;
d) selecting at least one best fit service provider by the matching program;
e) creating an initial work order through the matching program in communication with a service order program executed by a service order processor, the service order program generating the initial work order by combining the service request, home profile and a service provider profile received from the matching program;
f) sending the initial work order from the matching program to at least one selected service provider, wherein a service provider receives the initial work order through a service provider portal interface or electronic mail or combination thereof;
g) receiving an acceptance of the initial work order from an available service provider, the acceptance being sent through a service provider portal to the matching program;
h) selecting at least one best fit, available service provider as a final service provider through an analysis of one or more available service providers, the analysis performed by the matching program;
i) sending information for the final service provider from the matching program to the service order program;
j) creating a final work order through the final service provider information, service request, customer information, and home profile;
k) sending the final work order from the service order program to the final service provider through a service provider portal, electronic mail, or combination thereof;
k) receiving the final work order by the final service provider;
l) completing the final work order by the final service provider;
m) submitting a completed final work order by the final service provider through a service provider portal to the service order processor; and
n) updating the home profile database through the service order processor with information of the completed work order.

14. The method of claim 13, wherein the home profile of step b) comprises purchase, maintenance, repair, improvement, infrastructure, appliances, decorative appointments, exterior, interior design, home network, and safety devices information; diagrams, as-built drawings, plan drawings, appliance manuals, user manuals, photographs, warranty documents, home system characteristics, requiring maintenance, home appliance characteristics, updates, history of service requests, in-process work orders, completed work orders or combinations thereof.

15. The method of claim 13, wherein the service provider database of step c) comprises service provider contact and profile data, skill sets, geographical proximity, licensing, insurance, references, ratings, historical information of customer satisfaction with past performance or combinations thereof.

16. The method of claim 13, wherein the customer information of step b) provides for input of user name, contact information, address, and payment method.

17. The matching program of the method of claim 13, wherein the matching program selects at least one best fit match based on variables including dates and times selected by the user, total number of visits required to complete the service request, quality rating of the service provider, geographic location of the user, service provider availability, or user criteria ranking or combinations thereof.

18. A computer-implemented home maintenance and service method for facilitating computer-implemented, automatic creation of a home service transaction, the method comprising:
a) receiving a service request for maintenance and service of a home sent from a customer through a customer component of a computer-implemented brokering system;
b) creating a work order through computer processor components of the brokering system, the brokering system components matching the service request to at least one best fit service provider; and
c) providing the work order from the computer-implemented brokering system to the best fit service provider through a service provider component of the computer-implemented brokering system.

19. The method of claim 18, wherein creating a work order in the computer-implemented brokering system in step b) further comprises:
i) receiving the service request in a service request receiver processor of the brokering system;
ii) sending the service request from the service request receiver processor to a service request match processor;
iii) analyzing the service request by a matching program executed by the service request match processor, wherein the matching program: compares the service request with service provider profile information, generates a list of at least one potential service provider best suited to the service request, and generates a potential work order;
iv) sending the list of at least one potential service provider and the potential work order to a broadcaster processor programmed to dispatch the potential work order to the list of at least one potential service provider through an electronic mail broadcaster or a service provider component broadcaster or a combination thereof;
v) dispatching the potential work order from the broadcaster processor to at least one potential service provider through electronic mail, a service provider component, or a combination thereof;
vi) receiving a response from the potential service provider sent from a service provider component to a candidate service provider processor;
vii) generating a list of at least one candidate service contractors by the candidate service provider processor from one or more responses received;
viii) sending the list of at least one candidate service contractor from the candidate service provider processor to the service request match processor;
ix) analyzing the list of at least one candidate service provider by a work order assignment coordinator program executed by the service request match processor; wherein the work order assignment coordinator program generates a work order that is assigned to at least one best fit service provider;
x) sending the work order from the service request match processor to the customer component for confirmation of the work order by the customer;
xi) confirming of the work order by the customer through sending the work order from the customer component to a work order dispatch processor; and
xii) providing the work order to the at least one best fit service provider by dispatching the work order from the work order dispatch processor to a contractor component.

20. The method of claim 19, wherein the work order assignment coordinator in step ix) assigns the work order to at least one best fit service provider by a decision making program that analyzes candidate service provider variables including dates and times requested by the customer for the service request, total number of visits required to complete the service request, quality rating of the service provider, geographic location of the user, service provider availability, or user criteria ranking or combinations thereof.
